(19) United States
(12) Patent Application Publication
(10) Pub. No.: US 2008/0224872 A1
(43) Pub. Date: Sep. 18, 2008

(54) Circulation management system and circulation management apparatus

(75) Inventor: Tomomitsu Murano, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 12/076,269

(22) Filed: Mar. 14, 2008

(30) Foreign Application Priority Data
Mar. 14, 2007 (JP) 2007-065618

(51) Int. Cl. G08B 13/22

(52) U.S. Cl. 340/572.1

(57) ABSTRACT

A circulation management system is provided that includes an object identification tag attached to an object for identifying the object; multiple interrogator antennas for detecting the object identification tag, the interrogator antennas being provided for corresponding destinations to which the object is circulated; and a management apparatus to which the interrogator antennas are connected. The management apparatus is configured to determine by which one of the interrogator antennas the object identification tag is detected, thereby determining that the object having the object identification tag attached thereto belongs to one of the destinations for which the one of the interrogator antennas is provided. A table is provided in which the correspondence between the object identification tag and the object is recorded, and the object whose circulation status is managed by attaching the object identification tag thereto is identified by referring to the table.

### BACKGROUND OF THE INVENTION

1. Field of the Invention

The present invention relates to a circulation management system and a circulation management apparatus.

2. Description of the Related Art

In general, in circulating a document, a predetermined circulation list (a hard copy) is created that lists individuals to whom the document is to be circulated, and the document is passed on from one individual to another in the circulation list with the circulation list being attached to the document. As a result, the material is circulated to each individual listed as a circulation destination.

When delivering the document to another individual in the attached circulation list, each individual puts her/his signature on the circulation list, thereby indicating that she/he has checked or read the document, that is, the document has been circulated to her/him.

Thus, each individual listed as a circulation destination has to put her/his signature for acknowledging circulation of the document, which is a circular, every time the document is delivered to her/him, which takes time and effort. Further, the document may be re-circulated to the individual if she/he forgets to put her/his signature or the document may not be circulated to the individual if she/he erroneously puts her/his signature although she/he has not checked or read the document. Further, it is also possible that the document stops at some individual of a circulation destination.

Further, the circulation list has to be modified or newly created every time there is an organizational change or an increase or decrease in the number of members in the organization, which takes time and effort and also results in consumption of paper resources.

Further, there has been a demand for a system that enables an individual to leave a note when she/he finds information related to the business in her/his charge or interesting information in the circulated document, and to make quick reference to it at any time later.

Reference may be made to the following documents for related technologies.

[Patent Document 1] Japanese Laid-Open Patent Application No. 2006-185151

[Patent Document 2] Japanese Laid-Open Patent Application No. 2006-243928

### SUMMARY OF THE INVENTION

Embodiments of the present invention may solve or reduce one or more of the above-described problems.

According to one or more embodiments of the present invention, there are provided a circulation management system and a circulation management apparatus in which one or more of the above-described problems may be solved or reduced.

According to one embodiment of the present invention, there is provided a configuration capable of managing the circulation (circulation status) of a circular with effectiveness and efficiency.

According to one embodiment of the present invention, there is provided a circulation management system including an object identification tag attached to an object for identifying the object; a plurality of interrogator antennas for detecting the object identification tag, the interrogator antennas being provided for corresponding destinations to which the object is circulated; and a management apparatus to which the interrogator antennas are connected, wherein the management apparatus is configured to determine by which one of the interrogator antennas the object identification tag is detected, thereby determining that the object having the object identification tag attached thereto belongs to one of the destinations for which the one of the interrogator antennas is provided, and a table is provided in which a correspondence between the object identification tag and the object is recorded, and the object whose circulation status is managed by attaching the object identification tag thereto is identified by referring to the table.

According to one embodiment of the present invention, there is provided a circulation management system including an object identification tag attached to an object for identifying the object; a plurality of interrogator antennas for detecting the object identification tag, the interrogator antennas being provided for corresponding individual persons to whom the object is circulated; a plurality of individual identification tags attached to the corresponding individual persons for identifying the individual persons; and a management apparatus to which the interrogator antennas are connected, wherein the management apparatus is configured to determine that the object belongs to one of the individual persons in response to detecting the object identification tag and one of the individual identification tags for identifying the one of the individual persons through one of the interrogator antennas provided for the one of the individual persons.

According to one embodiment of the present invention, there is provided a circulation management apparatus using an object identification tag attached to an object for identifying the object and a plurality of interrogator antennas for detecting the object identification tag, the interrogator antennas being provided for corresponding destinations to which the object is circulated, the circulation management apparatus including a determination part configured to determine by which one of the interrogator antennas the object identification tag is detected, thereby determining that the object having the object identification tag attached thereto belongs to one of the destinations for which the one of the interrogator antennas is provided; a table provision part configured to provide a table in which a correspondence between the object identification tag and the object is recorded; and an identification part configured to identify the object, whose circulation status is managed by attaching the object identification tag thereto, by referring to the table.

According to one embodiment of the present invention, there is provided a circulation management apparatus using an object identification tag attached to an object for identifying the object; a plurality of interrogator antennas for detecting the object identification tag, the interrogator antennas being provided for corresponding individual persons to whom the object is circulated; and a plurality of individual identification tags attached to the corresponding individual persons for identifying the individual persons, the circulation management apparatus including a determination part configured to determine that the object belongs to one of the individual persons in response to detecting the object identification tag and one of the individual identification tags for identifying the one of the individual persons through one of the interrogator antennas provided for the one of the individual persons.

Thus, according to one aspect of the present invention, it is possible to provide a circulation management system capable of managing a circular object with efficiency and effectiveness, making effective use of an object identification tag, and effectively preventing omission of a circulation destination by performing personal authentication as well.

### BRIEF DESCRIPTION OF THE DRAWINGS

Other objects, features and advantages of the present invention will become more apparent from the following detailed description when read in conjunction with the accompanying drawings, in which:

FIG. 1A is a diagram showing an apparatus arrangement of a circular document management system and FIG. 1B is a diagram showing electrical connections among apparatuses forming the circular document management system according to an embodiment of the present invention;

FIGS. 2A and 2B are a plan view and a side view, respectively, for illustrating the principal axis and directivity (effective electromagnetic field strength) of an interrogator antenna in the case of not applying a man identification tag in the circular document management system shown in FIGS. 1A and 1B according to the embodiment of the present invention, where it is assumed that the radiated electromagnetic waves are symmetrical;

FIGS. 3A and 3B are a plan view and a side view, respectively, for illustrating the principal axis and directivity (effective electromagnetic field strength) of the interrogator antenna in the case of applying the man identification tag in the circular document management system shown in FIGS. 1A and 1B according to the embodiment of the present invention, where it is assumed that the radiated electromagnetic waves are symmetrical;

FIG. 4 is a diagram (table) showing a structure of a circular document DB master in the circular document management system shown in FIGS. 1A and 1B according to the embodiment of the present invention;

FIG. 5 is a diagram (table) showing a structure of an individual circular document DB in the circular document management system shown in FIGS. 1A and 1B according to the embodiment of the present invention;

FIG. 6 is a diagram (table) showing a structure of an individual place DB master in the circular document management system shown in FIGS. 1A and 1B according to the embodiment of the present invention;

FIG. 7 is a diagram (table) showing a structure of a place-interrogator antenna correspondence DB in the circular document management system shown in FIGS. 1A and 1B according to the embodiment of the present invention;

FIG. 8 is a diagram (table) showing a structure of a circulation group DB in the circular document management system shown in FIGS. 1A and 1B according to the embodiment of the present invention;

FIG. 9 is a diagram (table) showing a structure of the individual circular document DB in the case of applying the man identification tags in the circular document management system shown in FIGS. 1A and 1B according to the embodiment of the present invention;

FIG. 10 is an operational flowchart for illustrating a schematic flow of the processing by a user service control program executed by an interrogator host in the circular document management system shown in FIGS. 1A and 1B according to the embodiment of the present invention;

FIG. 11 is an operational flowchart for illustrating the processing by a circulation status monitoring operation program executed by the interrogator host in the circular document management system shown in FIGS. 1A and 1B according to the embodiment of the present invention;

FIG. 12 is a flowchart for illustrating a circular document registering operation by a user service control program executed by the interrogator host in the circular document management system shown in FIGS. 1A and 1B according to the embodiment of the present invention;

FIG. 13 is a flowchart for illustrating an individual registering operation or a circulation group registering operation by the user service control program executed by the interrogator host in the circular document management system shown in FIGS. 1A and 1B according to the embodiment of the present invention;

FIG. 14 is a flowchart for illustrating a record correcting operation by the user service control program executed by the interrogator host in the circular document management system shown in FIGS. 1A and 1B according to the embodiment of the present invention;

FIG. 15 is a flowchart for illustrating a record deleting operation by the user service control program executed by the interrogator host in the circular document management system shown in FIGS. 1A and 1B according to the embodiment of the present invention;

FIG. 16 is a flowchart for illustrating a document position checking (determining) operation by the user service control program executed by the interrogator host in the circular document management system shown in FIGS. 1A and 1B according to the embodiment of the present invention;

FIG. 17 is a flowchart for illustrating a memo retaining/status changing operation by the user service control program executed by the interrogator host in the circular document management system shown in FIGS. 1A and 1B according to the embodiment of the present invention;

FIG. 18 is a diagram for illustrating a configuration of a service screen displayed on a terminal in the circular document management system according to the embodiment of the present invention;

FIG. 19 is a diagram showing an example of the service screen (the first-level entry frame of the circular document registering operation) displayed on the terminal in the circular document management system according to the embodiment of the present invention;

FIG. 20 is a diagram showing an example of the service screen (the second-level entry frame of the circular document registering operation) displayed on the terminal in the circular document management system according to the embodiment of the present invention;

FIG. 21 is a diagram showing an example of the service screen (the first-level entry frame of an individual registering operation) displayed on the terminal in the circular document management system according to the embodiment of the present invention;

FIG. 22 is a diagram showing an example of the service screen (the second-level entry frame of the individual registering operation) displayed on the terminal in the circular document management system according to the embodiment of the present invention;

FIG. 23 is a diagram showing an example of the service screen (the first-level entry frame of a circulation group registering operation) displayed on the terminal in the circular document management system according to the embodiment of the present invention;

FIG. 24 is a diagram showing an example of the service screen (the second-level entry frame of the circulation group registering operation) displayed on the terminal in the circular document management system according to the embodiment of the present invention;

FIG. 25 is a diagram showing a command hierarchical structure of the service screen displayed on the terminal in the circular document management system according to the embodiment of the present invention;

FIGS. 26A and 26B are diagrams showing a circular notice e-mail message and a delay warning e-mail message, respectively, transmitted from the interrogator host to users in the circular document management system shown in FIGS. 1A and 1B according to the embodiment of the present invention; and

FIG. 27 is a diagram for illustrating a hardware configuration of a computer applicable as the interrogator host in the circular document management system shown in FIGS. 1A and 1B according to the embodiment of the present invention.

### DETAILED DESCRIPTION OF THE PREFERRED EMBODIMENTS

A description is given below, with reference to the accompanying drawings, of a system for managing an object to be circulated (circular object), such as a document to be circulated for a decision or approval or a document to be circulated for providing information, according to an embodiment of the present invention. Here, a document is one of examples of circular objects, which may include papers and other forms of paper media such as electronic paper as described below. Hereinafter, “a document to be circulated for a decision or approval or a document to be circulated for providing information” is simply referred to as “a circular document” and such a system is referred to as “a circular document management system.”

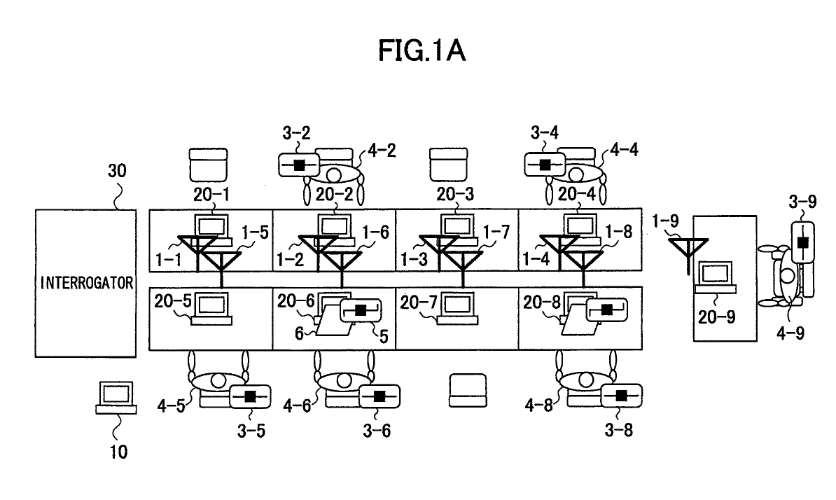

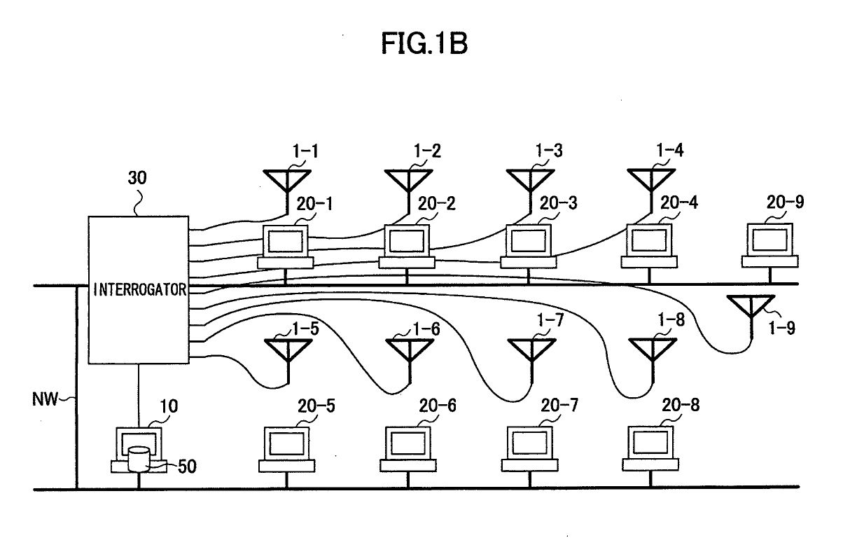

FIGS. 1A and 1B are diagrams for illustrating an application to a circular document management system according to the embodiment of the present invention. FIG. 1A is a diagram showing an apparatus arrangement of the circular document management system and FIG. 1B is a diagram showing electrical connections among apparatuses forming the circular document management system according to the embodiment of the present invention.

As shown in FIGS. 1A and 1B, the circular document management system according to this embodiment includes a document identification tag 5 attached or stuck to a document 6 to be circulated for a decision or approval or for checking or reading, an interrogator 30 that performs radio communications with the document identification tag 5, interrogator antennas 1-1 through 1-9 (hereinafter collectively referred to as “interrogator antennas 1”) provided in the places of users 4-1 through 4-9 (hereinafter collectively referred to as “users 4”) to whom the document 6 is to be circulated, and an interrogator host 10 (formed of a computer) that controls the interrogator 30 and provides services to the users 4. In FIG. 1A, the users 4-1, 4-3, and 4-7 are away from their places and are not shown in the drawing. The place of each user 4 may be, for example, individual room or space provided for each user 4.

In the office where the desks of the users 4 who are circulation destinations are arranged, the document 6 is circulated from one to another among the users 4 to whom the document has not been circulated.

Here, in addition to the document identification tag 5 attached to the document 6, man identification tags 3-1 through 3-9 (hereinafter collectively referred to simply as “man identification tags 3”) to be attached or stuck to the corresponding users 4 may also be provided. In FIG. 1A, the man identification tags 3-1, 3-3, and 3-7 are not shown for the reason stated above.

The users 4 have their respective interrogator antennas 1 provided therefor.

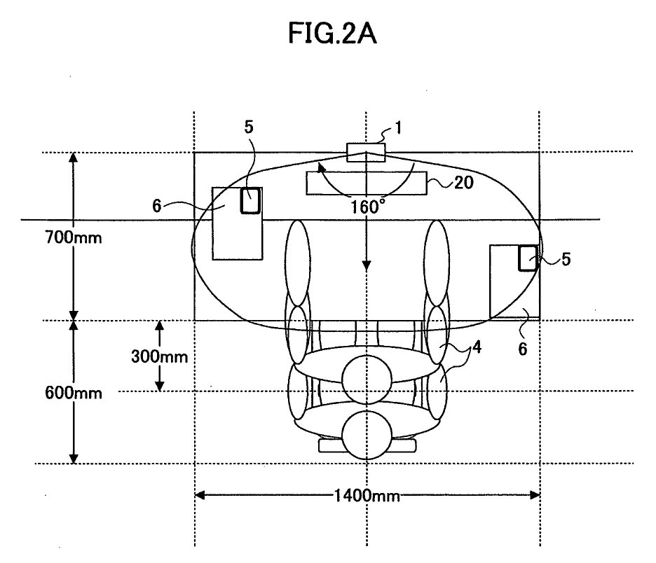

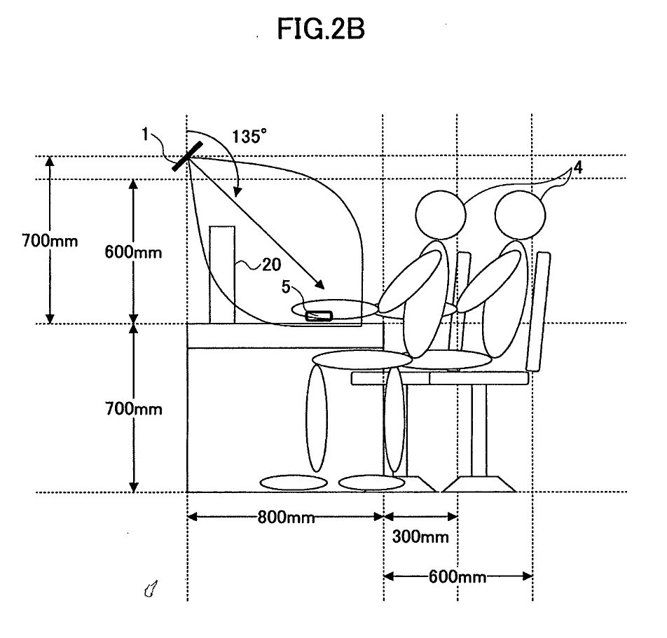

FIGS. 2A and 2B are a plan view and a side view, respectively, for illustrating the principal axis and directivity (effective electromagnetic field strength) of the interrogator antenna 1 in the case of not applying the man identification tag 3 in the circular document management system shown in FIGS. 1A and 1B. In FIGS. 2A and 2B, it is assumed that the radiated electromagnetic waves are symmetrical.

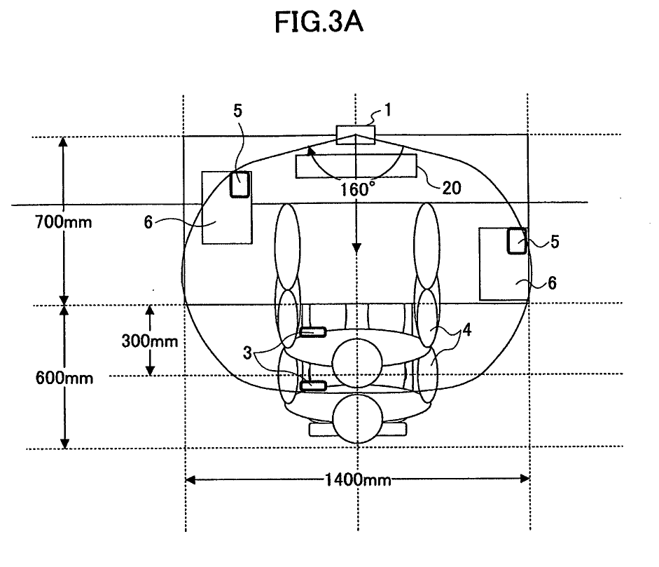

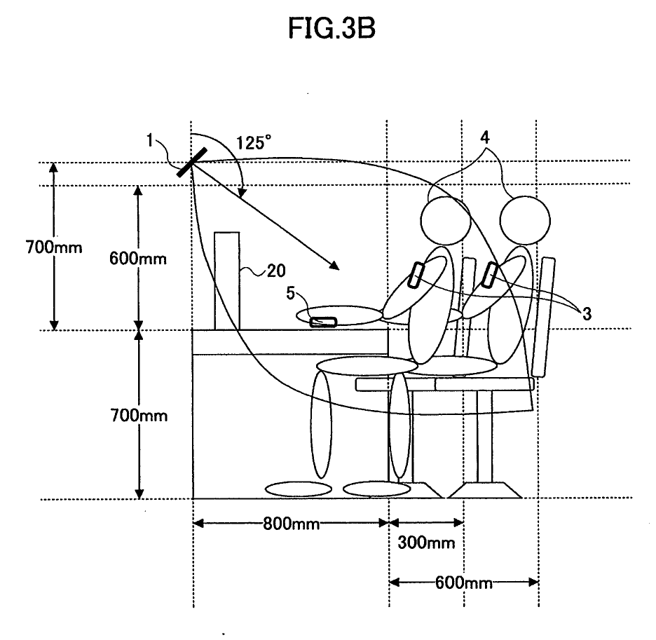

FIGS. 3A and 3B are a plan view and a side view, respectively, for illustrating the principal axis and directivity (effective electromagnetic field strength) of the interrogator antenna 1 in the case of applying the man identification tag 3 in the circular document management system shown in FIGS. 1A and 1B. In FIGS. 3A and 3B, it is assumed that the radiated electromagnetic waves are symmetrical.

As shown in FIGS. 2A and 2B or FIGS. 3A and 3B, the area of the effective electromagnetic field strength, that is, electromagnetic field strength that causes the authentication success rate of a known RFID (Radio Frequency Identification) tag to be more than or equal to a certain value, of each interrogator antenna 1 is set within a physical range where the user 4 does routine work (desk work). This set range is adjusted so as not to overlap the range of another user 4.

As a result, the document 6 with the document identification tag 5 attached thereto does not belong to the area of the effective electromagnetic field strength of the interrogator antenna 1 provided for the corresponding user 4 before the document 6 is placed on the desk of the user 4. When the document 6 is placed on the desk of the user 4, the document 6 can be detected by the interrogator antenna 1.

As shown in FIG. 1B, the interrogator 30 is connected to each interrogator antenna 1, and is further connected to the interrogator host 10.

The interrogator host 10 is connected to the interrogator 30, and is connected to a network NW such as a LAN. The users 4 have their respective terminals 20-1 through 20-9 (hereinafter collectively referred to simply as “terminals 20”) connected to this network NW.

The interrogator host 10 is a server and includes a hard disk unit 50 (FIG. 1B). The interrogator host 10 retains various databases in the hard disk unit 50 and provides various functions of the circular document management system of this embodiment. In practice, the users 4 can use various services by accessing a service site provided by the interrogator host 10 on their respective terminals 20 as described below.

As described above, FIGS. 2A and 2B shows the principal axis and directivity (effective electromagnetic field strength) of each interrogator antenna 1, specifically showing the effective electromagnetic field strength of the interrogator antenna 1 in the case of learning about (determining) the circulation status of the document 6 from (based on) the position information of the document identification tag 5.

Here, a description is given of the position information of the document identification tag 5.

The interrogator 30 gets electrically connected to the interrogator antennas 1 one by one at different specific times by switching from one interrogator antenna 1 to another in a predetermined manner. As a result, when the document identification tag 5 is detected through any of the interrogator antennas 1, it is possible to know through which one of the interrogator antennas 1 the document identification tag 5 has been detected and when the reception was made. Consequently, it is recognized that the document identification tag 5 is at the place of the user 4 to which the one of the interrogator antennas 1 belongs (corresponds). The information on the location of the document identification tag 5 thus obtained is the position information of the document identification tag 5.

In this manner, the position information of the document identification tag 5 is detected by the interrogator 30 through one of the interrogator antennas 1 during circulation of the document 6. When it is determined that the document identification tag 5 has moved, the circulation status of the user 4 from whom the document identification tag 5 has moved is changed to CIRCULATED, and the circulation status of the user 4 to whom the document identification tag 5 has moved is obtained as CURRENT POSITION.

Like FIGS. 2A and 2B, FIGS. 3A and 3B show the principal axis and directivity (effective electromagnetic field strength) of each interrogator antenna 1. Specifically, FIGS. 3A and 3B show the effective electromagnetic field strength of the interrogator antenna 1 in the case of learning about (determining) the circulation status of the document 6 from (based on) information on authentication by the man identification tag 3 and the position information of the document identification tag 5.

In this case, as shown in FIGS. 3A and 3B, the range of the effective electromagnetic field strength of the interrogator antenna 1 is adjusted to a range where the man identification tag 3 attached to the user 4 is detectable when the user 4 is seated (in her/his place). Accordingly, the man identification tag 3 attached to the user 4 is not detectable by the corresponding interrogator antenna 1 before the user 4 is seated.

The man identification tag 3 is also formed of the same RFID tag as that of the document identification tag 5, and is detected by the interrogator 30 through any of the interrogator antennas 1. If it is determined that the detected ID (that is, identification information) of the man identification tag 3 is that of the user 4 corresponding to the interrogator antenna 1 through which the ID of the man identification tag 3 has been detected, it is determined that personal authentication of the user 4 has succeeded. The information on authentication success or failure thus obtained corresponds to authentication information.

In this case, when the document identification tag 5 is detected by the interrogator 30 through one of the interrogator antennas 1 during circulation of the document 6 and it is determined from the position information of the document identification tag 5 and the authentication information of the man identification tag 3 of the user 4 of a circulation destination obtained at this point that the document identification tag 5 has moved, the circulation status of the user 4 to whom the document identification tag 5 has moved is obtained as CURRENT POSITION and the circulation status of the user 4 from whom the document identification tag 5 has moved is obtained as CIRCULATED.

Thus, according to the circular document management system of the embodiment of the present invention, the document identification tag 5 is attached or stuck to the document 6, which is an object to be circulated, as shown in FIGS. 1A and 1B. As described above, this document identification tag 5 is formed of an RFID tag.

Further, the interrogator antenna 1 is provided for the desk of each user 4, and each interrogator antenna 1 has directivity as shown in FIGS. 2A and 2B or FIGS. 3A and 3B. If the document identification tag 5 is positioned on the desk of any user 4, the document identification tag 5 is detected by the corresponding interrogator antenna 1.

As a result, the interrogator 30, having a function as an RFID reader/writer (transmission and reception part), reads the ID of the document identification tag 5 through the interrogator antenna 1, and detects (determines) the position of the interrogator antenna 1, that is, through which interrogator antenna 1 the ID of the document identification tag 5 has been read, and a change over time in the position.

Here, for example, as described above, the interrogator 30 periodically (for example, at intervals of one second) switches from one to another among the interrogator antennas 1 electrically connected to the interrogator as shown in FIG. 1B. That is, every few seconds, the interrogator 30 switches its connection destination in order from the interrogator antenna 1-1 to the interrogator antenna 1-2 to the interrogator antenna 1-3, etc., and always obtains information on when (at which time) and to which interrogator antenna 1 the interrogator 30 is connected. As a result of this configuration, when the document identification tag 5 has been detected through any of the interrogator antennas 1, it is possible to readily identify the interrogator antenna 1 through which the document identification tag 5 has been detected.

In this manner, it is possible to determine, at any time, through which interrogator antenna 1 the document identification tag 5 has been detected. As a result, it is possible to understand, with ease and certainty, which one of the places (that is, desks) of the users 4 the document 6 is currently in (on), and when (at which point of time) and from which one to which one of the places of the users 4 the document identification tag 5 has been moved.

That is, when the document 6 is in the place (for example, on the desk) of one of the users 4, the circulation status of the place of the one of the users 4 (the user 4) with respect to the document 6 is obtained as CURRENT POSITION. Further, when the document 6 makes transition from this status to the status where the document 6 is not in the place of the user 4, that is, when the document identification tag 5 has been once detected but is not detected thereafter through the interrogator antenna 1 in the place, the circulation status of the place with respect to the document 6 is obtained as CIRCULATED. Further, when the document 6 has not been in the place, that is, the document identification tag 5 has not been detected through the interrogator antenna 1 in the place, the circulation status of the place is obtained as NOT YET CIRCULATED.

In this manner, at any time, the circulation status of CIRCULATED, CURRENT POSITION, or NOT YET CIRCULATED can be obtained with respect to each of the places of the users 4, so that it is possible to effectively manage the circulation status of the document 6.

Regarding the above-described problem of the circulation list (hard copy), according to the circular document management system of this embodiment, it is assumed that a person who is a source of the circular document 6 pre-registers the circulation destination users 4 (to whom the document 6 is to be circulated) with the circular document management system. Further, when the first arrival of the circular document 6 at the place (for example, desk) of one of the users 4 is detected, the one of the users 4 is notified of the arrival of the document 6 and provided with additional information on the individuals (users 4) to which the document 6 has not been circulated by means of electronic mail or the like. As a result, the circulation list (hard copy) is not required any more.

Regarding the above-described problem of searching in the case of a circulation delay or the loss of a circular object, according to the circular document management system of this embodiment, it is possible to easily detect the remaining of the document 6 in the place (or on the desk) of any of the users 4. That is, if the above-described circulation status of CURRENT POSITION continues for more than a predetermined set time (below-described alarm time), this may be detected as the remaining of the document 6 in the place (or on the desk) of the user 4. In such a case, it is possible to alert the user 4 by transmitting a notice (below-described delay warning) to the user 4 by way of electronic mail, and it is also possible to know the location of the document 6 with ease.

Further, for each individual user 4, an individual circular document DB (database) (FIG. 5) is provided, and a memorandum (memo) item is provided for the record of each document. The individual circular document DB may be configured so as to allow each user 4 to leave a note in the corresponding memorandum item field with ease.

Thus, according to the embodiment of the present invention, the circular document management system includes the document identification tag 5 attached or stuck to the document 6 that is an object of circulation, the interrogator 30 that performs radio communications with the document identification tag 5, the interrogator antennas 1 provided for the places of the users 4 of the system, and the interrogator host 10 that controls the interrogator 30 and provides services to the users 4. The document 6 includes electronic paper, that is, a display medium that electronically displays characters. In the case of the document 6 being electronic paper, the document identification tag 5 may be integrated with or incorporated in the document 6.

Alternatively, the circular document management system according to this embodiment may include the document identification tag 5 attached or stuck to the document 6 to be circulated, the man identification tags 3 attached or stuck to the users 4 of the system, the interrogator 30 that performs radio communications with the document identification tag 5 and the man identification tags 3, the interrogator antennas 1 provided for the places of the users 4, and the interrogator host 10 that controls the interrogator 30 and provides services to the users 4.

The interrogator antennas 1 are provided place by place (desk by desk).

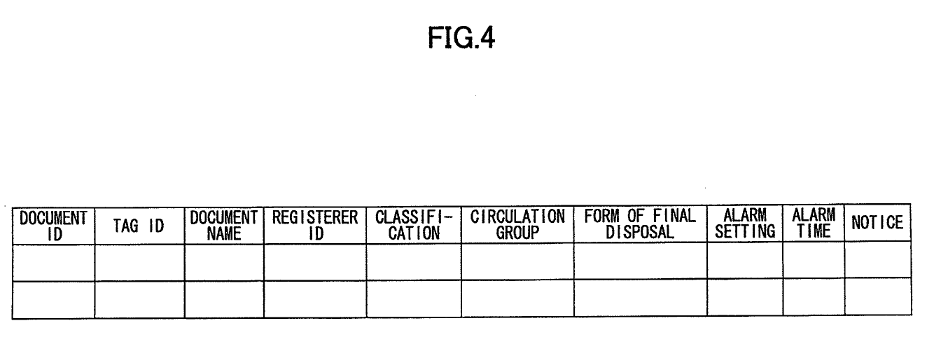

The interrogator host 10 has the function of managing and controlling additional information such as circulation group information in addition to necessary information such as document information necessary for circulation, individual (personal) circulation information, individual (personal) place information, and information on the correspondence between the places of the users 4 and the interrogator antennas 1 (place-interrogator antenna correspondence information). (See FIG. 4 through FIG. 9.)

FIG. 4 is a diagram (table) showing a structure of a circular document DB master in the circular document management system shown in FIGS. 1A and 1B.

As shown in FIG. 4, in addition to information such as a document name, a document ID, a document identification tag ID, and a source (that is, registerer) ID, the document information may include additional information such as document classification such as FOR AUTHORIZED PERSONNEL ONLY, FOR INTERNAL USE ONLY, or GENERAL, a circulation group that identifies each individual of circulation destination, a form of final disposal, alarm setting, alarm time, and copy prohibition.

FIG. 5 is a diagram (table) showing a structure of the individual circular document DB in the circular document management system shown in FIGS. 1A and 1B.

As shown in FIG. 5, in addition to information such as a personal ID, a document ID, and a circulation status, the individual circulation information may include additional information such as an arrival date and time and a memorandum (note).

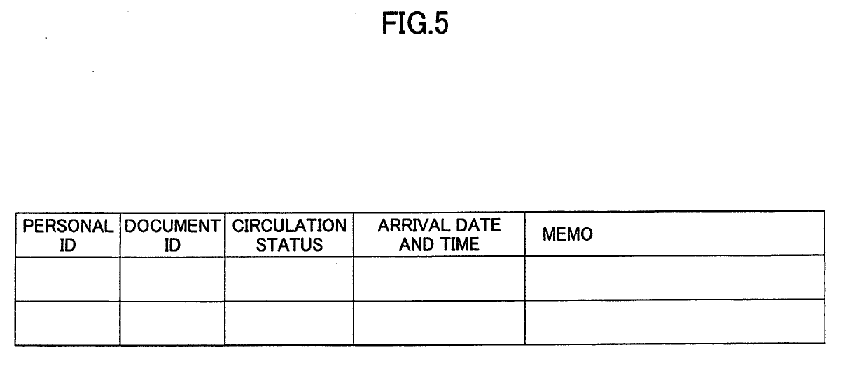

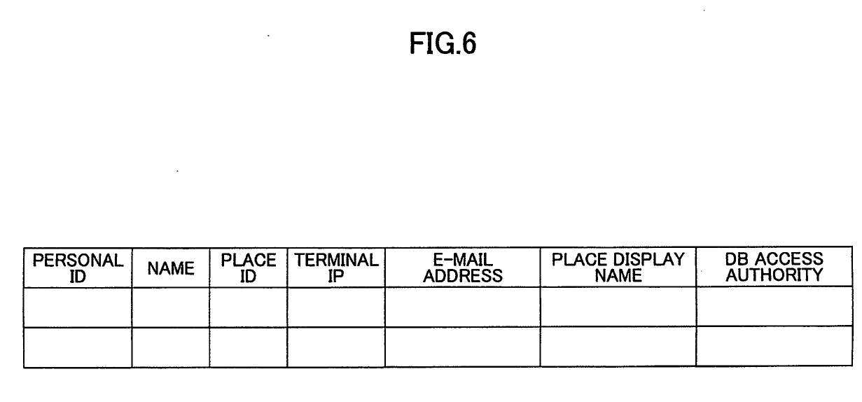

FIG. 6 is a diagram (table) showing a structure of an individual place DB master in the circular document management system shown in FIGS. 1A and 1B.

As shown in FIG. 6, in addition to information such as a personal ID, a name, a place ID, and a terminal IP, the individual place information may include additional information such as an e-mail address, a place display name, and DB access authority.

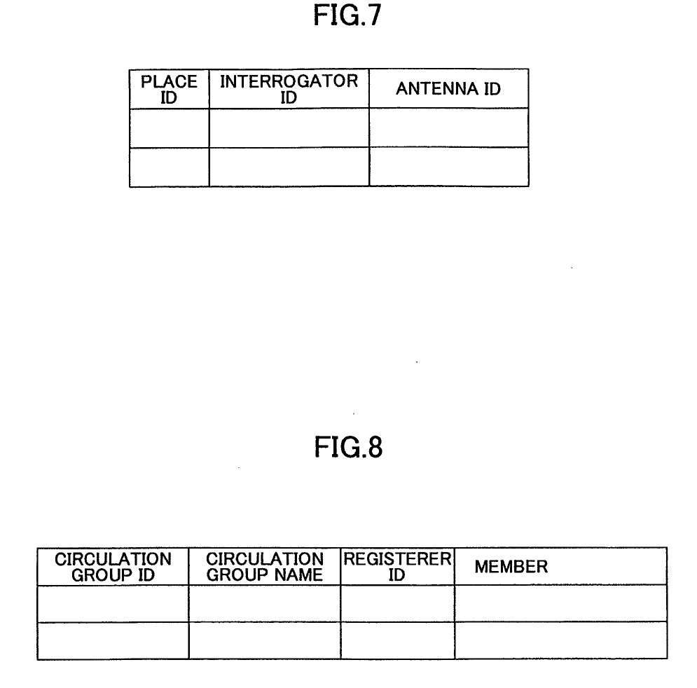

FIG. 7 is a diagram (table) showing a structure of a place-interrogator antenna correspondence DB in the circular document management system shown in FIGS. 1A and 1B.

As shown in FIG. 7, the place-interrogator antenna correspondence information may include a place ID, an interrogator ID, and an antenna ID.

FIG. 8 is a diagram (table) showing a structure of a circulation group DB in the circular document management system shown in FIGS. 1A and 1B. A description is given below of the circulation group DB.

Further, a person who is a source of the circular document 6 with the document identification tag 5 enters information on the document 6 in the interrogator host 10, and causes the ID of the document identification tag 5 to be authenticated by the system through the interrogator antenna 1 provided for the place of the source, so that the document 6 with the document identification tag 5 is registered with the system.

When the document 6 with the document identification tag 5 is read by the interrogator 30 through any of the interrogator antennas 1 during its circulation, a circulation status such as CIRCULATED or NOT YET CIRCULATED is written into the individual circular document DB as shown in FIG. 5 of the corresponding circulation destination user 4 based on the position information of the document 6.

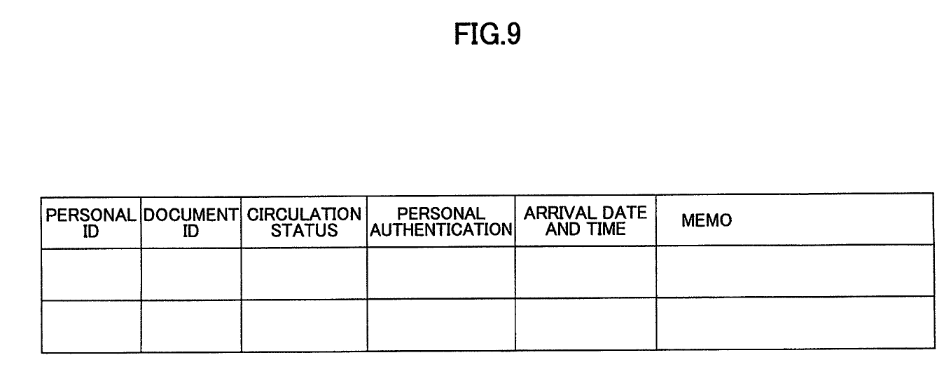

Further, when the document 6 with the document identification tag 5 is read by the interrogator 30 through any of the interrogator antennas 1 during its circulation, a circulation status such as CURRENT POSITION (that is, being checked or read), CIRCULATED, or NOT YET CIRCULATED is written into the individual circular document DB as shown in FIG. 9 of the corresponding circulation destination user 4 based on the position information of the document 6 and the authentication information of the user 4 (man identification tag 3). FIG. 9 is a diagram (table) showing a structure of the individual circular document DB in the case of applying the man identification tags 3 in the circular document management system shown in FIGS. 1A and 1B.

Further, as described above, one of different circulation statuses such as CURRENT POSITION, CIRCULATED, or NOT YET CIRCULATED is written into the field of CIRCULATION STATUS in the individual circular document DB as shown in FIG. 5 or FIG. 9.

Further, the document ID of the document information is automatically assigned to the document 6 by the interrogator host 10 at the time of its registration.

Circulation destinations may be listed for the circulation group, or the circulation group is specified by a pre-registered circulation group name.

Further, when a change in the position information of the document 6 with the document identification tag 5 thus registered is read during its circulation, a circulation notice is transmitted, by, for example, e-mail, to the user 4 of the place to which the document 6 has moved.

Further, if the document 6 remains in one place (on one desk) for more than the alarm time with the alarm setting being selected (checked), a delay warning is given to the user 4 of the place through, for example, transmission of an e-mail message.

Further, the interrogator host 10 controls the interrogator 30 so that the interrogator 30 transmits a identification tag authenticating signal through each interrogator antenna 1 periodically or in accordance with a predetermined time schedule.

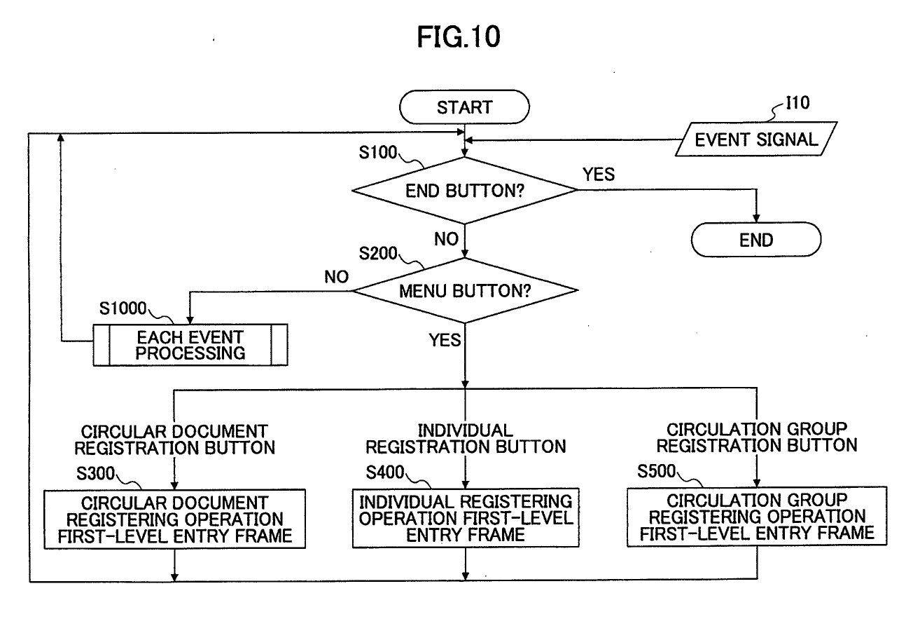

A detailed description is given below, with reference to the operational flowcharts of FIG. 10 through FIG. 17, of the specifics of information processing in the circular document management system having the above-described configuration according to the embodiment of the present invention.

This information processing is automatically executed by the interrogator host 10, which is a computer, executing predetermined programs.

FIG. 10 is an operational flowchart for illustrating a schematic flow of the processing by a user service control program executed by the interrogator host 10.

This user service control program controls signal transmission and reception in the interrogator 30 and processes service requests (events) by the users 4.

If the user 4 (one of the users 4) operates the corresponding terminal 20 to access the service site of the circular document management system provided by the interrogator host 10, the user service control program is activated so as to wait for a service request (that is, an event signal [I10 in FIG. 10] generated by clicking on a corresponding button) from the user 4.

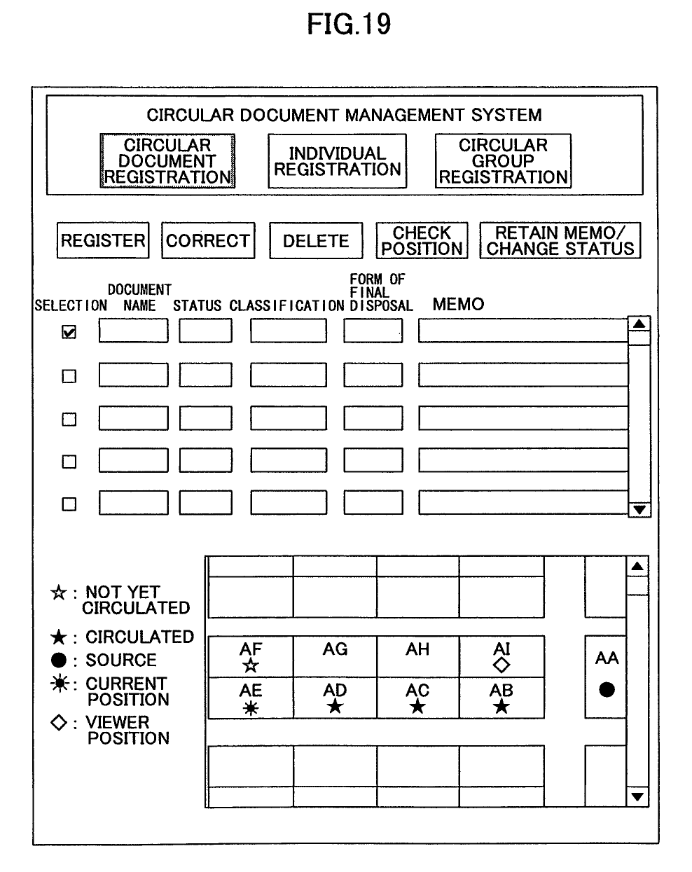

Here, if the user 4 clicks an END (EXIT) button (not graphically illustrated) displayed on a service screen of the service site (for example, a screen shown in FIG. 19), that is, the user 4 performs an operation to close the browser (YES in step S100), this program ends.

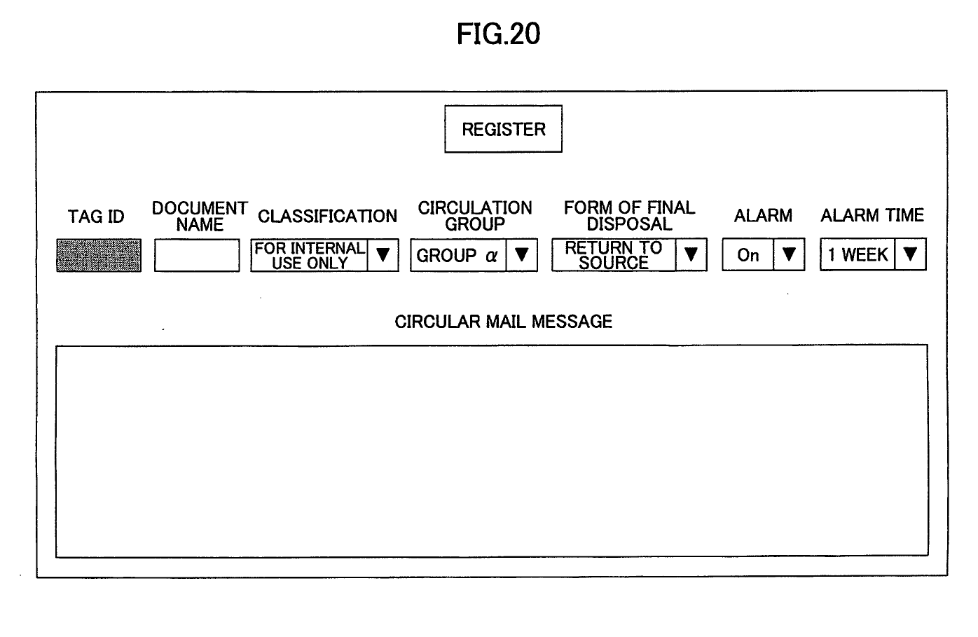

FIG. 18 is a diagram for illustrating a configuration of a service screen displayed on the terminal 20 according to the circular document management system of this embodiment. FIG. 19 is a diagram showing an example of the service screen (the first-level entry frame of a circular document registering operation) displayed on the terminal 20 according to the circular document management system of this embodiment. FIG. 20 is a diagram showing an example of the service screen (the second-level entry frame of the circular document registering operation) displayed on the terminal 20 according to the circular document management system of this embodiment.

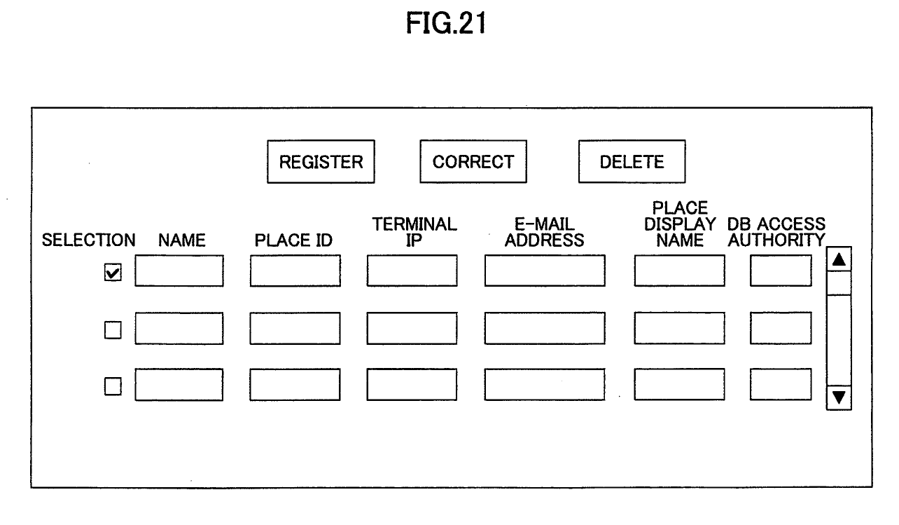

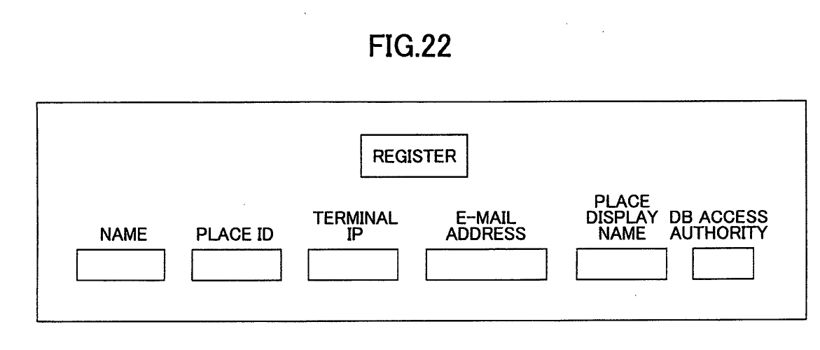

FIG. 21 is a diagram showing an example of the service screen (the first-level entry frame of an individual registering operation) displayed on the terminal 20 according to the circular document management system of this embodiment. FIG. 22 is a diagram showing an example of the service screen (the second-level entry frame of the individual registering operation) displayed on the terminal 20 according to the circular document management system of this embodiment.

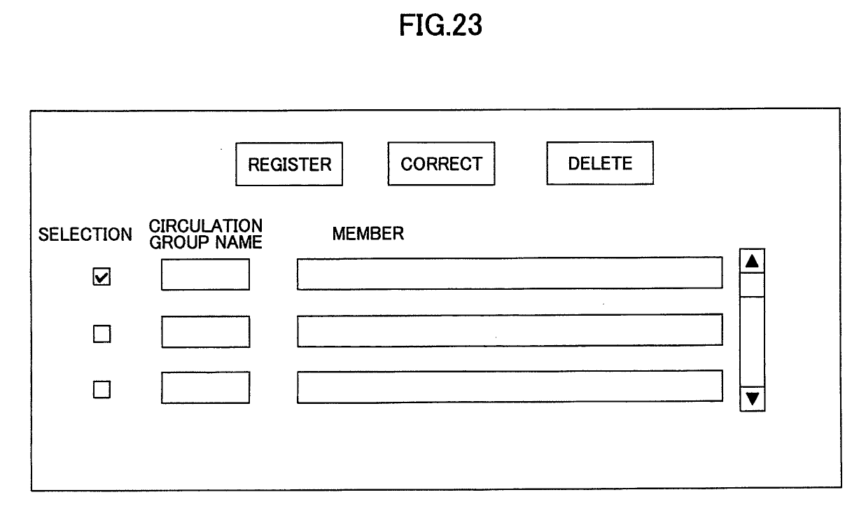

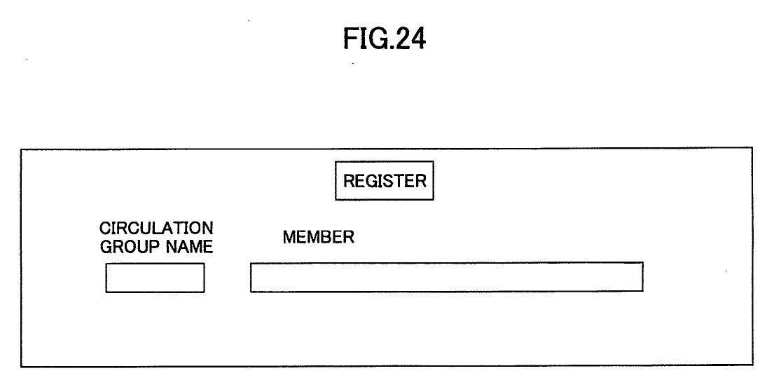

FIG. 23 is a diagram showing an example of the service screen (the first-level entry frame of a circulation group registering operation) displayed on the terminal 20 according to the circular document management system of this embodiment. FIG. 24 is a diagram showing a service screen (the second-level entry frame of the circulation group registering operation) displayed on the terminal 20 according to the circular document management system of this embodiment.

This service screen has a tripartition frame configuration as shown in FIG. 18. In the service screen, a menu frame where menu buttons are displayed is provided at the top, an entry frame (the first-level entry frame or the second-level entry frame described below) is placed in the middle, and a document status display frame described below is provided at the bottom (the bottom of FIG. 19). FIG. 20 through FIG. 24 show only the entry frame in the middle of the service screen.

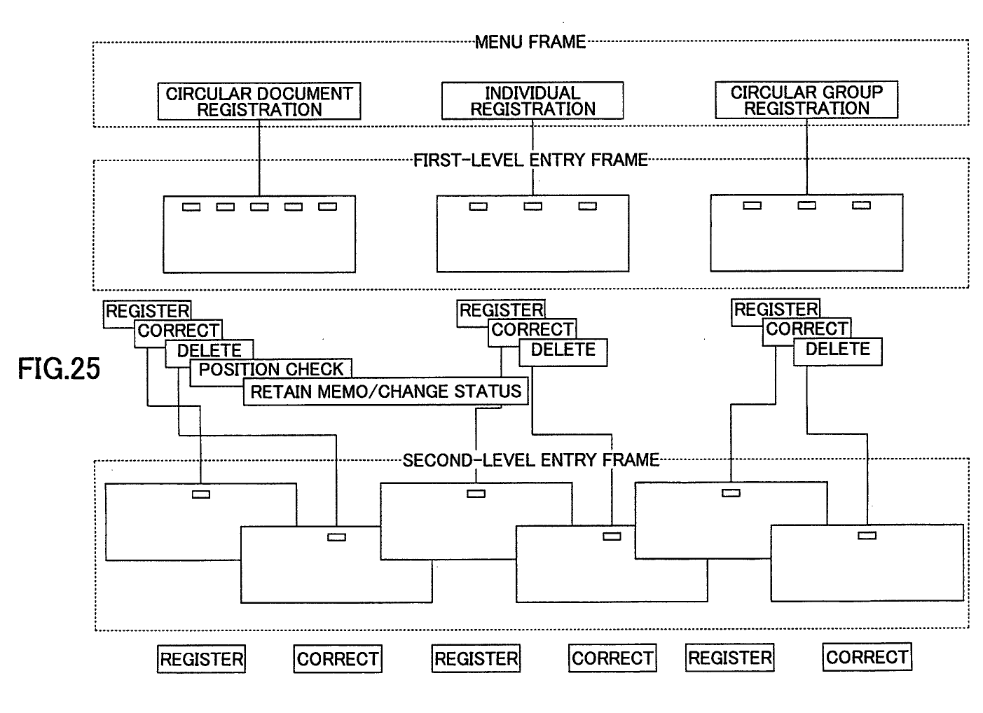

FIG. 25 is a diagram showing a command hierarchical structure of the service screen displayed on the terminal 20 according to the circular document management system of this embodiment.

As shown hierarchically in FIG. 25, when a CIRCULAR DOCUMENT REGISTRATION button in the menu frame is clicked on the service screen, a corresponding first-level entry frame, that is, the screen of FIG. 19 is displayed. When an INDIVIDUAL REGISTRATION button in the menu frame is clicked on the service screen, a corresponding first-level entry frame, that is, the screen of FIG. 21 is displayed. When a CIRCULATION GROUP REGISTRATION button in the menu frame is clicked on the service screen, a corresponding first-level entry frame, that is, the screen of FIG. 23 is displayed.

Further, if an event button of these first-level entry frames, such as a REGISTER button or a CORRECT button, is clicked during their display, corresponding processing such as REGISTRATION EVENT processing or CORRECTION EVENT processing is executed. In the corresponding processing, a corresponding second-level entry frame screen, that is, the screen of FIG. 20 in the circular document registering operation, the screen of FIG. 22 in the individual registering operation, or the screen of FIG. 24 in the circulation group registering operation, is displayed.

If a menu button of the service screen, specifically, the CIRCULAR DOCUMENT REGISTRATION button, the INDIVIDUAL REGISTRATION button, or the CIRCULATION GROUP REGISTRATION button (in the menu frame at the top of FIG. 19), is clicked (YES in step S200), the first-level entry frame of the corresponding menu (the screen of FIG. 19, FIG. 21, or FIG. 23) is displayed (step S300, step S400, or step S500).

Next, when the user 4 clicks a button in the displayed first-level entry frame, a second-level entry frame screen corresponding to the button (the second-level entry frame of FIG. 25 and the screen of FIG. 20, FIG. 22, or FIG. 24) is displayed, and corresponding event processing is executed (event signal: S1000). A description is given below of the specific contents of the event processing.

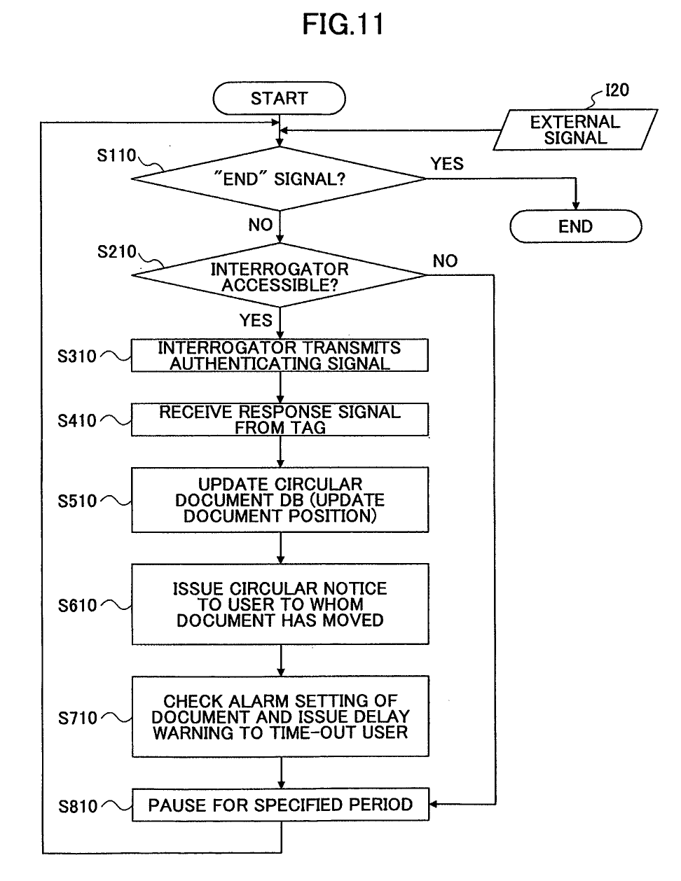

FIG. 11 is an operational flowchart of the circulation status monitoring operation by a circulation status monitoring operation program executed by the interrogator host 10.

This circulation status monitoring operation program is activated, automatically or by the user 4 who is the system administrator of the circular document management system, independent of the above-described processing (operation) by the user service control program.

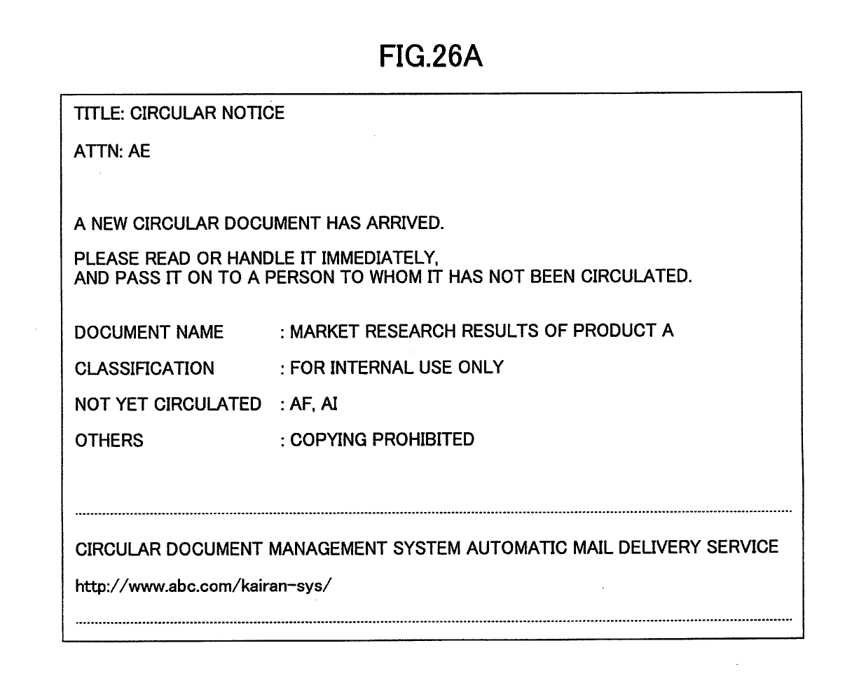

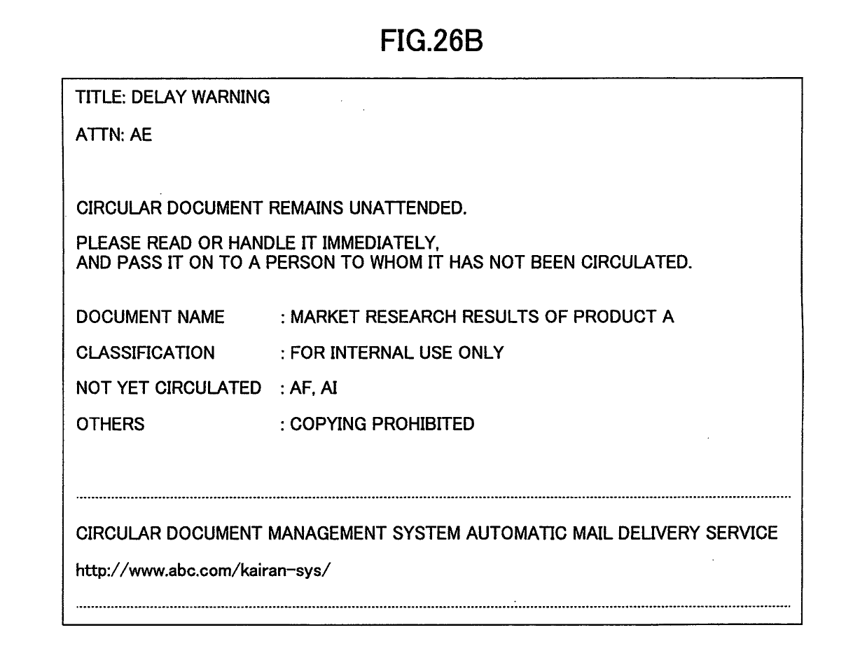

This circulation status monitoring operation program executed by the interrogator host 10 causes the interrogator 30 to transmit an authenticating signal through the interrogator antennas 1 periodically (for example, every 30 minutes) or in accordance with a predetermined time schedule, obtains the latest position of the document identification tag 5 through the known RFID technology, and provides a service such as notifying the users 4 of a circular notice (FIG. 26A) or a delay warning (FIG. 26B) based on the obtained information.

In the operation of FIG. 11, first, an END signal (I20) (external signal) from the system administrator is monitored for (in step S110), and the processing (operation) ends in response to reception of the END signal (I20).

Next, in step S210, it is determined whether the interrogator 30 is accessible. For example, the interrogator 30 may not be accessible if a service user 4 (client) is using the interrogator 30.

If it is determined in step S210 that the interrogator 30 is accessible (YES in step S210), in step S310, a predetermined authenticating signal is transmitted from the interrogator 30 through the interrogator antennas 1. The predetermined authenticating signal corresponds to the identification tag ID registered for each circular document (document ID) in the circular document DB master shown in FIG. 4. In this step, periodically, the authenticating signals corresponding to the registered identification tag IDs are transmitted in predetermined order on a registered identification tag ID basis. At this point, as described above, the interrogator antenna 1 to be used is periodically switched from one to another in predetermined order (that is, switching is performed). In step S410, a response signal to this interrogation is received from the document identification tag 5.

That is, if the circular document 6 with the document identification tag 5 having a identification tag ID related to the above-described registration is within the effective electromagnetic field strength range of any of the interrogator antennas 1, that is, on the desk of the corresponding user 4, a response signal is transmitted from the document identification tag 5 in response to the authenticating signal, so as to be received by the interrogator 30 through the corresponding interrogator antenna 1.

Here, as described above, periodically, the authenticating signals corresponding to the registration-related identification tag IDs are transmitted in predetermined order, and the interrogator antenna 1 to be used is also periodically switched from one to another in predetermined order. Accordingly, based on the time of reception of the response signal, it is possible to identify the authenticating signal of the identification tag ID to which the response signal is responsive, and it is also possible to identify the interrogator antenna 1 through which the response signal has been received with respect to each authenticating signal. As a result, it is possible to identify the circular document 6 registered in the circular document DB master of FIG. 4 to which the response signal corresponds, and it is possible to identify the desk of the user 4 on which the corresponding circular document 6 is.

In step S510, by thus identifying the interrogator antenna 1 through which the response signal has been received from the document identification tag 5, the current position of the document 6 with the document identification tag 5 is determined, and the individual circular document DB shown in FIG. 5 is updated based on the determination result.

That is, as described above, the circulation status of the user 4 of the place where the document identification tag 5 is currently detected is obtained as CURRENT POSITION, and the circulation status of the user 4 is obtained as CIRCULATED if the document identification tag 5 is not detected thereafter. If the document identification tag 5 has not yet been detected, the circulation status of the user 4 is obtained as NOT YET CIRCULATED. These circulation statuses are written into the CIRCULATION STATUS item column of the individual circulation document DB.

Here, in the case of applying the man identification tags 3, only when the document identification tag 5 is detected through any of the interrogator antenna 1, that is, the circulation status of the corresponding user 4 is changed to CURRENT POSITION, and personal authentication of the user 4 is established, the circulation status of the user 4 in the individual circular document DB shown in FIG. 9 is updated to CIRCULATED when the document identification tag 5 thereafter becomes undetectable through the interrogator antenna 1 of the user 4.

With respect to the personal authentication, it is determined that the authentication has succeeded when the arrival of the document identification tag 5 at the user 4 is detected in response to reception of the response signal from the document identification tag 5 through the corresponding interrogator antenna 1 (belonging to the user 4) in step S410 and the personal ID of the user 4 having the corresponding place ID registered with the individual place DB master shown in FIG. 6 is thereafter detected through the same interrogator antenna 1. In this case, in the man identification tag 3 attached to each user 4, the personal ID of the user 4 is embedded. If it is determined that the authentication has succeeded, the corresponding field of the PERSONAL AUTHENTICATION item is updated to ON in the individual circular document DB shown in FIG. 9.

If the document 6 has moved since the previous time, in step S610, a circular notice (FIG. 26A) is given to the user 4 to whom the document 6 has moved.

Further, if the document 6 remains at the same position (or in the same place) as at the previous time, an alarm is set for the document 6, and a time out occurs, that is, the document 6 continues to be detected for more than a set alarm (period of) time (for example, a week), in step S710, a delay warning (FIG. 26B) is given to the user 4.

Then, after a pause for a specified period of time in step S810, the operation of rechecking the position of the document 6, updating the individual circular document DB, and giving a circular notice or a delay notice if necessary is repeated (steps S210 through S710).

The operations of steps S210 through S810 are repeated until the END signal I20 is received from the system administrator (YES in step S110).

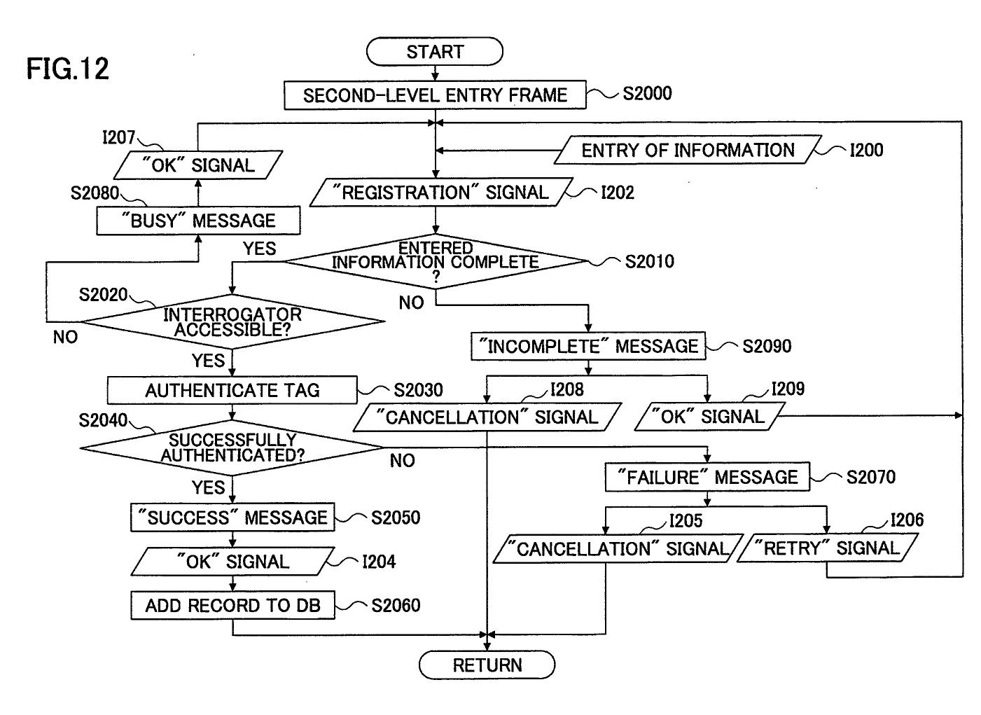

FIG. 12 through FIG. 17 are operational flowcharts showing the flows of processing events, that is, user requests, in step S1000 of FIG. 10.

The operation of step S1000 is executed by the user 4 performing a predetermined operation on the corresponding terminal 20 connected to the network NW shown in FIG. 1B.

That is, the user 4 accesses the service site of the circular document management system shown in FIG. 19 on the terminal 20, causes the service screen to be displayed on the terminal 20, and clicks a corresponding button, so that corresponding user request processing is performed.

FIG. 12 is an operational flowchart of the registration event processing of the circular document registering operation.

First, the user 4 who is going to circulate the document 6 attaches or sticks a predetermined document identification tag 5 to the document 6. When the user 4 clicks, for example, the CIRCULAR DOCUMENT REGISTRATION button in the menu frame shown at the upper end of the screen of FIG. 19 currently displayed on the terminal 20, the first-level entry frame screen of the circular document registering operation of FIG. 19 is displayed in step S300 of FIG. 10. By clicking the REGISTER button on the displayed screen, the registration screen of the second-level entry frame of the circular document registering operation shown in FIG. 20 is displayed (step S2000 in FIG. 12).

Here, entry of information (I200) and a REGISTRATION signal (I202, generated by clicking of a REGISTER button) by the user 4 are awaited. When the user 4 enters (keys in) predetermined information and clicks the REGISTER button on the registration screen of FIG. 20 currently displayed, in step S2010, it is determined (checked) whether the information entered by the user is complete.

If the entered information is complete (YES in step S2010), in step S2020, it is determined whether the interrogator 30 is accessible. If the interrogator 30 is accessible (YES in step S2020), in step S2030, the document identification tag 5 attached to the registered document 6 is authenticated. That is, the identification tag ID of the document identification tag 5 is read by known RFID technology. Thereafter, in step S2040, it is determined whether the document identification tag 5 has successfully been authenticated, that is, the identification tag ID of the document identification tag 5 has successfully been read. If the document identification tag 5 has successfully been authenticated (YES in step S2040), in step S2050, an AUTHENTICATION SUCCESS message is displayed.

If the user 4 clicks an OK button (not graphically illustrated) in response to this message, a corresponding OK signal (I204) is generated. In response to this signal, in step S2060, a corresponding registration record is added to the circular document DB master shown in FIG. 5 and the individual circular document DB shown in FIG. 5.

On the other hand, if the document identification tag 5 has not successfully been authenticated (NO in step S2040), in step S2070, a FAILURE message is displayed. If the user 4 clicks a CANCEL button (not graphically illustrated) in response to this message, a CANCELLATION signal I205 is generated, and the screen returns to the first-level.

On the other hand, if the user 4 clicks a RETRY button (not graphically illustrated) in response to the FAILURE message, a RETRY signal I206 is generated, and entry of information I200 is again awaited.

Further, if the interrogator 30 is not accessible (NO in step S2020), in step S2080, a BUSY message is displayed. Then, after entry of an OK signal (I207) by the user 4 clicking an OK button in response to this message, entry of information I200 is again awaited.

If the entered information is incomplete (NO in step S2010), in step S2090, an INCOMPLETE message is displayed. If the user 4 clicks a CANCEL button so that a CANCELLATION signal I208 is generated, the screen returns to the first-level.

If the user 4 clicks an OK button so that an OK signal I209 is generated, entry of information I200 is again awaited.

By the circular document registering operation of FIG. 12, the document 6 that is going to be circulated, along with the document identification tag 5 attached or stuck to the document 6 as described above, is registered with the circular document management system.

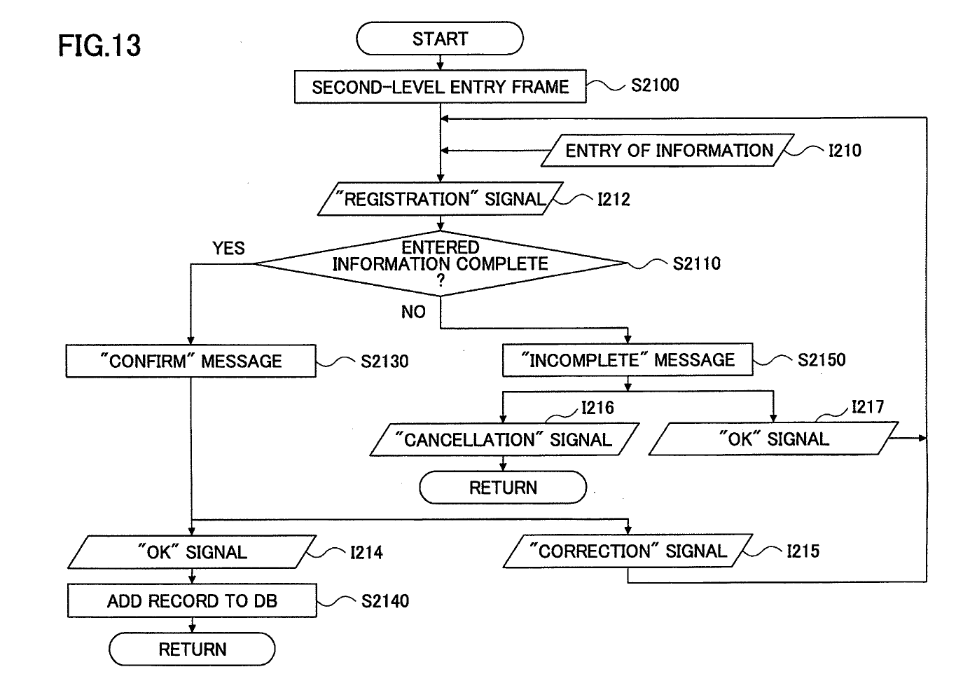

FIG. 13 is an operational flowchart of the registration event processing of the individual registering operation or the circulation group registering operation.

The individual registering operation registers a user for receiving various services provided by the circular document management system. Specifically, the individual registering operation registers information to be stored in the individual place DB master shown in FIG. 6.

The circulation group registering operation registers a circulation group that identifies the users 4 to whom the document 6 is to be circulated using the circular document management system. Specifically, the circulation group registering operation registers information to be stored in the circulation group DB shown in FIG. 8.

First, by clicking the INDIVIDUAL REGISTRATION button or the CIRCULATION GROUP REGISTRATION button in the menu frame shown at the upper end of FIG. 19, the first-level entry frame screen of the individual registering operation of FIG. 21 is displayed in step S400 of FIG. 10 or the first-level entry frame screen of the circulation group registering operation screen of FIG. 23 is displayed in step S500 of FIG. 10. By clicking a REGISTER button on the displayed screen, the registration screen of the second-level entry frame of the individual registering operation shown in FIG. 22 or the registration screen of the second-level entry frame of the circulation group registering operation shown in FIG. 24 is displayed (in step S2100 in FIG. 13).

In response to this, the user 4 enters information necessary for registration. The interrogator host 10 waits for such entry of information (I210) and entry of a REGISTRATION signal (I212, generated by clicking of a REGISTER button) by the user 4, and in step S2110, determines whether the entered information is complete.

If the entered information is complete (YES in step S2110), in step S2130, a CONFIRM message is displayed. If the user 4 clicks an OK button in response to this message so that an OK signal (I214) is obtained (generated), in step S2140, a corresponding registration record is added to the individual place DB master (FIG. 6) or the circulation group DB (FIG. 8).

On the other hand, in the case of a CORRECTION signal (I215) generated by clicking of a CORRECT button by the user 4, entry of information 1200 is again awaited.

If the entered information is incomplete (NO in step S2110), in step S2150, an INCOMPLETE message is displayed. If the user 4 clicks a CANCEL button so that a CANCELLATION signal I216 is generated, the screen returns to the first-level. If the user 4 clicks an OK button so that an OK signal I217 is generated, entry of information I200 is again awaited.

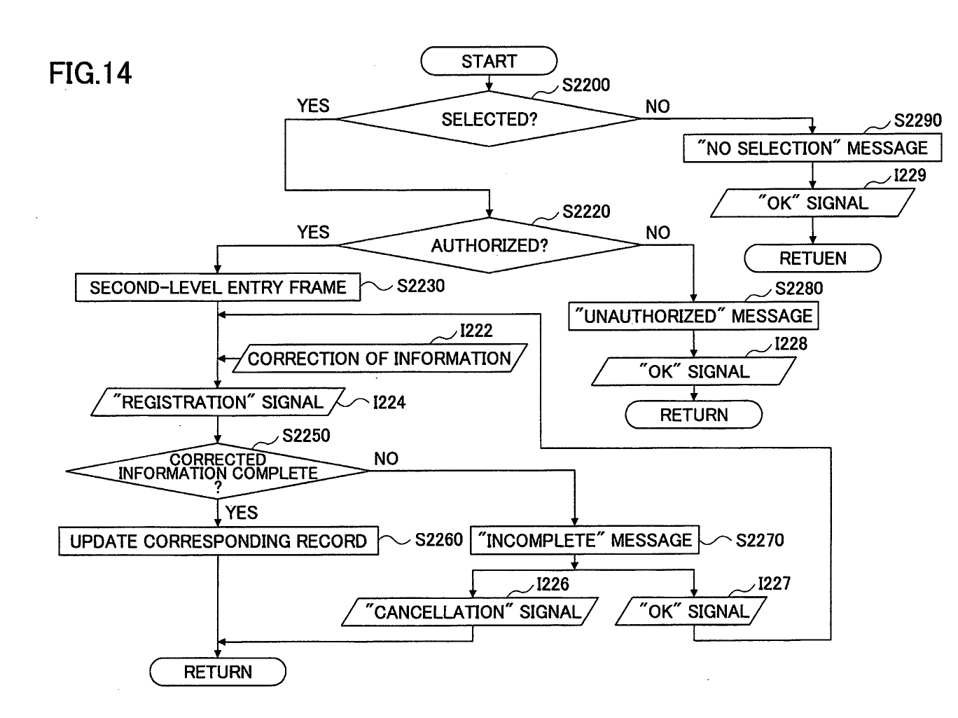

FIG. 14 is an operational flowchart of correction event processing for the user 4 correcting a record related to the above-described circular document registering operation, individual registering operation, or circulation group registering operation.

First, the user 4 selects (determines) a record that the user 4 wishes to correct from a list of records displayed in the first-level entry frame (FIG. 19, FIG. 21, or FIG. 23). If the interrogator host 10 determines that a record is selected (YES in step S2200), in step S2220, the interrogator host 10 determines whether the user 4 is authorized to correct the selected record.

Here, the interrogator host 10 determines the presence or absence of authority for the correction by collating the user ID of the user 4 who has currently logged on with the ID of a corresponding record registerer, the ID of the system administrator, and the ID of a specific user whose DB access authority is equal to that of the system administrator.

If it is determined that the user 4 has authority for the correction (YES in step S2220), in step S2230, the corresponding second-level entry frame (FIG. 20, FIG. 22, or FIG. 24) is displayed.

Then, after correction of information (I222) and generation of a REGISTRATION signal (I224) by clicking of a REGISTER button by the user 4, in step S2250, it is determined whether the information after the correction 1222 is complete. If the corrected information is complete (YES in step S2250), in step S2260, the contents of all databases related to the record are updated.

On the other hand, if the corrected information is incomplete (NO in step S2250), in step S2270, an INCOMPLETE message is displayed. If the user 4 clicks a CANCEL button so that a CANCELLATION signal I226 is generated, the screen returns to the first-level. If the user 4 clicks an OK button so that an OK signal (I227) is generated, correction of information I222 is again awaited.

On the other hand, if it is determined that the user 4 has no authority for the correction (No in step S2220), in step S2280, an UNAUTHORIZED message is displayed, and the screen returns to the first-level in response to an OK signal (I228) generated by an operation (clicking of an OK button) by the user 4.

Further, if no record is selected (NO in step S2200), in step S2290, a NO SELECTION message is displayed, and the screen returns to the first-level in response to an OK signal (I229) generated by an operation (clicking of an OK button) by the user 4.

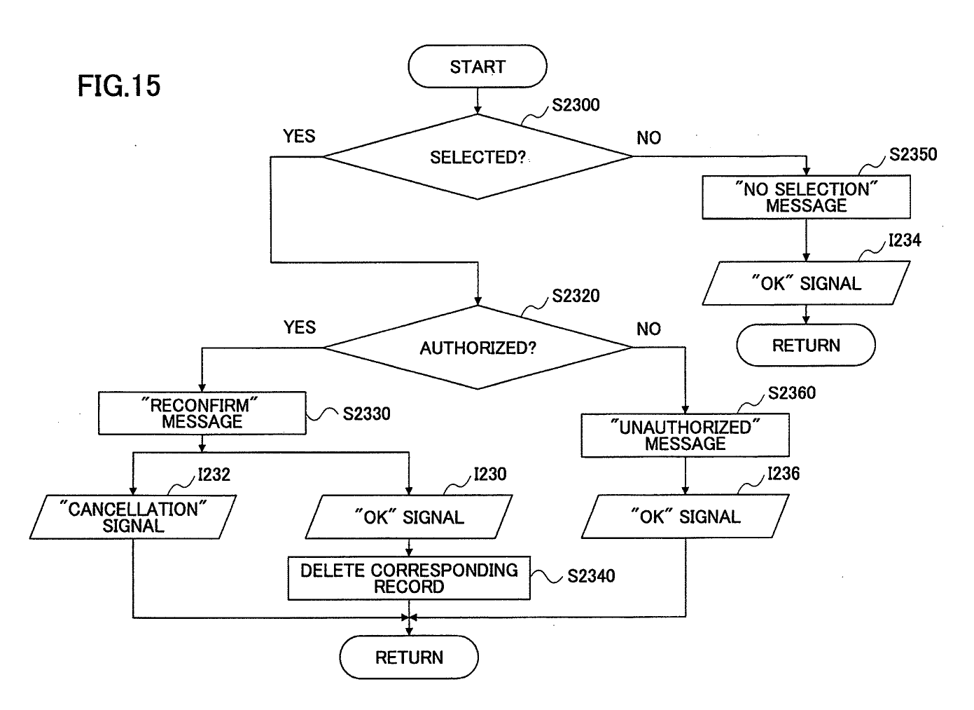

FIG. 15 is an operational flowchart of deletion event processing for the user 4 deleting a record related to the above-described circular document registering operation, individual registering operation, or circulation group registering operation.

First, in step S2300, it is determined whether one of the records displayed in a list in the first-level entry frame (FIG. 19, FIG. 21, or FIG. 23) is selected by the user 4 the same as in the above-described correction event.

If it is determined that one of the records is selected (YES in step S2300), in step S2320, it is determined whether the user 4 is authorized to delete the selected one of the records (selected record). Here, the presence or absence of authority for the deletion is also determined by collating the user ID of the user 4 who has currently logged on with the ID of a corresponding record registerer, the ID of the system administrator, and the ID of a specific user whose DB access authority is equal to that of the system administrator the same as in the case of the above-described correction authority.

If it is determined that the user 4 has authority for the deletion (YES in step S2320), in step S2330, a RECONFIRM message is displayed. In the case of an OK signal (I230) generated by an operation (clicking of an OK button) by the user 4, in step S2340, the record is deleted from the DB. In the case of a CANCELLATION signal (I232) generated by an operation (clicking of a CANCEL button) by the user 4, the screen returns to the first-level.

If it is determined that the user 4 has no authority for the deletion (NO in step S2320), in step S2360, an UNAUTHORIZED message is displayed, and the screen returns to the first-level in response to an OK signal (I236) generated by an operation by the user 4.

If no record is selected (NO in step S2300), in step S2350, a NO SELECTION message is displayed, and the screen returns to the first-level in response to an OK signal (I234) generated by an operation by the user 4.

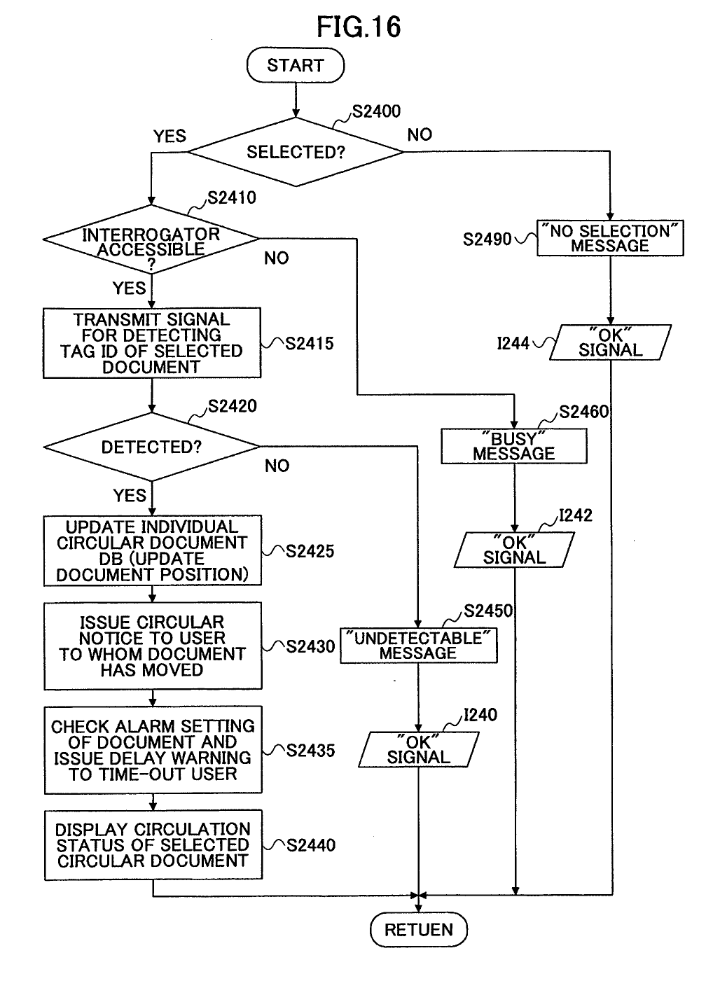

FIG. 16 is an operational flowchart of position checking (determining) event processing in the above-described circular document registering operation. This processing is executed by the user 4 (source) who has registered the document 6 to be circulated in the above-described circular document registering operation of FIG. 12 or each user 4 of the circulation group when wishing to know the current position of the document 6 currently circulated or the circulation status of each user 4 specified as a circulation destination.

First, in step S2400, it is determined whether the user 4 has selected a document 6 from the recorded circular documents 6 displayed in a list in the first-level entry frame (FIG. 19) of the circular document registering operation.

If any document 6 has been selected (YES in step S2400), in step S2410, it is determined whether the interrogator 30 is accessible. If the interrogator 30 is accessible (YES in step S2410), in step S2415, the identification tag ID of the document identification tag 5 registered with the circular document DB master shown in FIG. 4 is obtained (determined) with respect to the selected document 6, and in step S2420, it is determined whether the identification tag ID is detectable through any of the corresponding interrogator antennas 1 by the interrogator 30.

If the identification tag ID has been detected (YES in step S2420), in step S2425, the record of the user 4 corresponding to the interrogator antenna 1 related to the diction (the user 4 to whom the document 6 has been circulated) is properly updated in the individual circular document DB of FIG. 5.

That is, if the circulation status of the user 4 is NOT YET CIRCULATED, it is updated to CURRENT POSITION, and with respect to the record of the other user 4 from which the document 6 has moved, the circulation status is updated from CURRENT POSITION to CIRCULATED. Further, if the current circulation status in the record of the user 4 related to the detection is CURRENT POSITION, the record is not updated.

Here, in the case of applying the above-described man identification tags 3, only when the document identification tag 5 is detected through any of the interrogator antennas 1, that is, the circulation status of the corresponding user 4 is changed to CURRENT POSITION, and personal authentication of the user 4 is established, the circulation status of the user 4 in the individual circular document DB shown in FIG. 9 is updated to CIRCULATED when the document identification tag 5 thereafter becomes undetectable through the interrogator antenna 1 of the user 4.

Further, if the document 6 has moved from the previous time, in step S2430, a circular notice (FIG. 26A) is given to the user 4 to whom the document 6 has moved.

Further, if the document 6 remains at the same position (or in the same place) as at the previous time, an alarm is set for the document 6, and a time out occurs, that is, a set alarm (period of) time has elapsed, with respect the document 6, in step S2435, a delay warning (FIG. 26B) is given to the user 4.

Next, in step S2440, the circulation status of the selected circular document 6 is displayed in a document status display frame (at the bottom of FIG. 18 and at the bottom of the screen of FIG. 19).

That is, by one or more functions of the circular document management system according to this embodiment, information as to which desks of the places of the users 4 the circular document 6 with the document identification tag 5 has been through and which one of the desks of the places of the users 4 the circular document 6 with the document identification tag 5 is currently on is obtained through the known RFID technology as described above. The document status display frame is displayed based on the obtained information.

FIG. 19 shows the case where the currently selected document 6 is on the desk of the place of User AE; the document 6 has not been circulated to User AF, that is, the document identification tag 5 attached to the document 6 has not been detected through the interrogator antenna 1 of the place of User AF; and the document 6 has been circulated to Users AB, AC, and AD, that is, the document identification tag 5 attached to the document 6 has been once detected and is thereafter undetectable through the corresponding interrogator antenna 1 of the place of each of Users AB, AC, and AD.

This information in the document status display frame is displayed based on the information stored in the individual circular document DB of FIG. 5. That is, the records related to the currently selected document 6 are extracted from the individual circular document DB using a corresponding document ID as a key. Then, the records of Users AA through AI are extracted in order from the obtained records using their corresponding personal IDs as keys. Then, the item of CIRCULATION STATUS is read from each of the obtained users' records (records of Users AA through AI) related to the document 6. Then, information is displayed with respect to each of the users 4 (Users AA through AI) based on the obtained status information of NOT YET CIRCULATED, CURRENT POSITION, or CIRCULATED.

In the document status display frame of FIG. 19, Users AG, AH, and AI for whom no document status is displayed are those not registered as circulation destinations of the document 6.

Accordingly, regarding the document 6, no record is registered with respect to any of these users 4 (Users AG, AH, and AI) in the individual circular document DB. As a result, no circulation status is displayed with respect to any of these users 4 in the document status display frame of FIG. 19.

Here, the circulation destinations of the document 6 are recorded in the item of CIRCULATION GROUP of the record of the document 6 in the circular document DB master of FIG. 4 in the above-described circulation group registering operation. Users AG, AH, and AI do not belong to the circulation group registered with respect to the document 6.

Referring back to FIG. 16, if detection of the document identification tag 5 fails (NO in step S2420), in step S2450, an UNDETECTABLE (NO DETECTION) message is displayed, and the screen returns to the first-level in response to an OK signal (I240) generated by an operation by the user 4.

Further, if the interrogator 30 is not accessible (NO in step S2410), in step S2460, a BUSY message is displayed, and the screen returns to the first-level in response to an OK signal (I242) generated by an operation by the user 4.

Further, if no document (record) has been selected (NO in step S2400), in step S2490, a NO SELECTION message is displayed, and the screen returns to the first-level in response to an OK signal (I244) generated by an operation by the user 4.

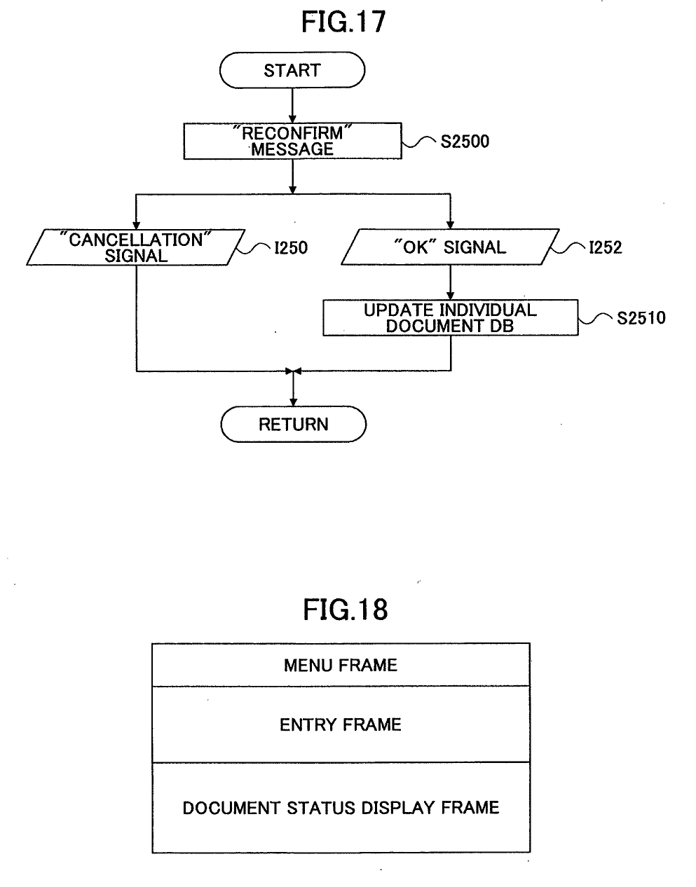

FIG. 17 is an operational flowchart of the memo retaining/status changing event processing of the circular document registering operation.

This processing is executed when the user 4 checks or confirms the contents of a memo that the user 4 has written into her/his own record (individual circular document DB) with respect to the circular document 6 or when the user 4 changes circulation status in her/his record (individual circular document DB).

In the case where the user 4 has written a memo (note), in step S2500, the interrogator host 10 outputs a RECONFIRM message. If an OK signal (I252) is generated by an operation by the user 4, in step S2510, the individual circular document DB is updated so as to reflect the memo written by the user 4, and the screen returns to the first-level. On the other hand, in the case of a CANCELLATION signal (I250), the screen returns to the first-level without updating the individual circular document DB.

Further, in the case of changing circulation status, in response to the RECONFIRM message (step S2500), the user 4 clicks an OK button if the corresponding circular document 6 has already arrived, or clicks a CANCEL button if the corresponding circular document 6 has not yet arrived. In response to the clicking of the OK button, the OK signal (I252) is transmitted from the terminal 20 of the user 4. In response to the OK signal, in step S2510, the interrogator host 10 updates the circulation status in the corresponding record of the user 4 to CURRENT POSITION. If the CANCEL button is clicked, the CANCELLATION signal (I250) is transmitted from the terminal 20 of the user 4. In this case, the screen returns to the first-level.

FIGS. 26A and 26B are diagrams showing a circular notice e-mail message and a delay warning e-mail message, respectively, transmitted from the interrogator host 10 to the users 4 in the circular document management system shown in FIGS. 1A and 1B.

The circular notice is issued in step S610 of the circulation status monitoring operation described above with reference to FIG. 11 and in step S2430 of the position checking operation described with reference to FIG. 16. The delay warning is issued in step S710 of the circulation status monitoring operation described above with reference to FIG. 11 and in step S2435 of the position checking operation described with reference to FIG. 16.

The circular notice of FIG. 26A includes confirmation of the delivery of the circular document 6 and an instruction on the subsequent processing (operation), that is, information on the next user 4 to whom the document 6 is to be delivered and an instruction for the user 4 to deliver the document 6 to the next user 4.

The delay warning of FIG. 26B includes an indication to the user 4 that the circular document 6 has not been handled and an instruction for the user 4 to deliver the document 6 to the user 4 of the next destination.

FIG. 18 is a diagram showing a service screen displayed on the terminal 20 according to the circular document management system of this embodiment.

As described above, the screen has a tripartition frame configuration. If the user 4 clicks a menu button in the menu frame at the top of the screen, a screen for performing the processing of a corresponding menu is displayed in the entry frame in the middle of the screen. Further, the circulation status of the document 6 is displayed in the document status display frame at the bottom of the screen by the operation of step S2440 described with reference to FIG. 16.

FIG. 25 is a diagram showing a command hierarchical structure of the service screen displayed on the terminal 20 according to the circular document management system of this embodiment.

As described above, if a menu button in the menu frame in the service screen is clicked, a corresponding first-level entry frame screen is displayed. Further, if an event button in the first-level entry frame screen is clicked, a corresponding second-level entry frame screen is displayed.

FIG. 19 is a diagram showing an example of the service screen (the first-level entry frame of the circular document registering operation) displayed on the terminal 20 according to the circular document management system of this embodiment.

As shown in FIG. 19, the menu frame is displayed at the top, a list of circular documents (the first-level entry frame of the circular document registering operation) is displayed in the middle, and a current circulation status of the document 6 selected from the circular document list in the middle is displayed at the bottom. The circular document list in the middle is displayed based on the information contained in the individual circular document DB of FIG. 5.

FIG. 20 is a diagram showing a service screen (the second-level entry frame of the circular document registering operation) displayed on the terminal 20 according to the circular document management system of this embodiment, which service screen is displayed by clicking the REGISTRATION button on the screen of FIG. 19 described above.

The user 4 who is a source of the circular document 6 registers the circular document 6 on the screen of FIG. 20. Specifically, this is executed by the circular document registering operation described above with reference to FIG. 12. That is, by steps S2020 through S2060 during the operation of FIG. 12, the document identification tag 5 attached to the circular document 6 to be sent out is registered, the name of the document 6 is entered, additional information such as FOR INTERNAL USE ONLY is entered, a circulation group for identifying the users 4 to whom the document 6 is to be circulated is specified (determined), a form of final disposition of the circular document 6 is specified (determined), an alarm is set, and an alarm time in the case of setting the alarm is set.

The setting of the alarm is related to the alarm checking and delay warning operation of step S710 in the circulation status monitoring operation described above with reference to FIG. 11 and step S2435 in the position checking operation described with reference to FIG. 16. That is, this setting makes it possible to detect the remaining of the circular document 6 at a user 4 and to give the above-described delay warning. In this case, if the circular document 6 remains at a specific user 4 for more than a period set as the alarm time, a delay warning is automatically given to the user 4.

The contents of the circular document 6 thus registered are contained in the circular document DB master shown in FIG. 4.

FIG. 21 and FIG. 22 are diagrams showing examples of the service screen (the first-level entry frame and the second-level entry frame, respectively, of the individual registering operation) displayed on the terminal 20 of the user 4 according to the circular document management system of this embodiment. The screen of FIG. 22 is displayed in response to clicking of the REGISTER button on the screen of FIG. 21.

Through operations performed on these screens by the user 4, the user 4 is registered with the circular document management system by the individual registering operation described above with reference to FIG. 13. That is, with respect to each user 4, the items of NAME, PLACE ID, TERMINAL IP, E-MAIL ADDRESS, PLACE DISPLAY NAME, and DB ACCESS AUTHORITY of the user 4 are registered.

These registered items are contained in the individual place DB master shown in FIG. 6.

FIG. 23 and FIG. 24 are diagrams showing examples of the service screens (the first-level entry frame and the second-level entry frame, respectively, of the circulation group registering operation) displayed on the terminal 20 according to the circular document management system of this embodiment. The screen of FIG. 24 is displayed in response to clicking of the REGISTER button on the screen of FIG. 23.

Through operations performed on these screens by the user 4, a circulation group is registered with the circular document management system by the circulation group registering operation described above with reference to FIG. 13. That is, a circulation group name for identifying circulation destinations and the users 4 (members) belonging to the circulation group are registered.

These registered items are contained in the circulation group DB shown in FIG. 8.

FIG. 4 is a diagram (table) showing a structure of the circular document DB master in the circular document management system shown in FIGS. 1A and 1B.

The circular document DB master is registered by the circular document registering operation described above with reference to FIG. 12. The circular document DB master is contained in the hard disk unit 50 (FIG. 1B) of the interrogator host 10. The CPU or the like of the computer forming the interrogator host 10 reads information from or writes information to the registered contents of the circular document DB master as required.

FIG. 5 is a diagram (table) showing a structure of the individual circular document DB in the circular document management system shown in FIGS. 1A and 1B.

The individual circular document DB is contained in the hard disk unit 50 (FIG. 1B) of the interrogator host 10. The CPU or the like of the computer forming the interrogator host 10 reads information from or writes information to the registered contents of the individual circular document DB as required.

That is, the contained information of this individual circular document DB is created based on the contained information of the circular document DB master of FIG. 4, the contained information of the individual place DB master of FIG. 6, and the contained information of the circulation group DB of FIG. 8.

That is, with respect to each of the records of document IDs registered with the circular document DB master of FIG. 4, a circulation group included in the record is extracted, and the users 4 belonging to the extracted circulation group are read from the circulation group DB of FIG. 8. A record of the individual circular document DB of FIG. 5 is created for each of the obtained (read) users 4 to whom the corresponding circular document 6 is to be circulated.

The circulation status and the arrival date and time of each record of the individual circular document DB thus created are written in step S510 of the circulation status monitoring operation described above with reference to FIG. 11, and are properly updated thereafter.

Further, writing to the memorandum item of each record of this individual circular document DB can be freely performed by the corresponding user 4. The memorandum item can be properly updated by the memo retaining/status changing operation described above with reference to FIG. 17.

FIG. 6 is a diagram (table) showing a structure of the individual place DB master in the circular document management system shown in FIGS. 1A and 1B.

This individual place DB master is registered by the individual registering operation described above with reference to FIG. 13. The individual place DB master is contained in the hard disk unit 50 (FIG. 1B) of the interrogator host 10. The CPU or the like of the computer forming the interrogator host 10 reads information from or writes information to the registered contents of the individual place DB master as required.

FIG. 7 is a diagram (table) showing a structure of the place-interrogator antenna correspondence DB in the circular document management system shown in FIGS. 1A and 1B.

As described above with reference to FIGS. 1A and 1B, FIGS. 2A and 2B, and FIGS. 3A and 3B, with respect to each of the places of the users 4, the ID of the corresponding interrogator 30 and the ID of the corresponding interrogator antenna 1 are registered with and contained as information in this place-interrogator antenna correspondence DB.

In the above-described circulation status monitoring operation of FIG. 11, when the document identification tag 5 is detected through a specific one of the interrogator antennas 1 (step S410), it is determined which one of the users 4 the specific interrogator antenna 1 belongs to by referring to the contained information of the individual place DB master of FIG. 6 and the place-interrogator antenna correspondence DB of FIG. 7, so that the record of the corresponding user 4 is properly updated in the individual circular document DB of FIG. 5 (step S510).

FIG. 8 is a diagram (table) showing a structure of the circulation group DB in the circular document management system shown in FIGS. 1A and 1B.

The circulation group DB is registered by the circulation group registering operation described above with reference to FIG. 13. The circulation group DB is contained in the hard disk unit 50 (FIG. 1B) of the interrogator host 10. The CPU or the like of the computer forming the interrogator host 10 reads information from or writes information to the registered contents of the circulation group DB as required.

FIG. 9 is a diagram (table) showing a structure of the individual circular document DB in the case of applying the man identification tags 3 in the circular document management system shown in FIGS. 1A and 1B.

This individual circular document DB corresponds to the individual circular document DB described above with reference to FIG. 5, but additionally includes the item of PERSONAL AUTHENTICATION as graphically illustrated.

In the case of applying the man identification tags 3, as described above with reference to FIG. 11 and FIG. 16, only when the document identification tag 5 is detected through any of the interrogator antenna 1 so that the circulation status of the corresponding user 4 is changed to CURRENT POSITION, and the user 4 has successfully been authenticated personally with the corresponding man identification tag 3, the circulation status of the user 4 in the individual circular document DB shown in FIG. 9 is updated to CIRCULATED when the document identification tag 5 thereafter becomes undetectable through the interrogator antenna 1 of the user 4.

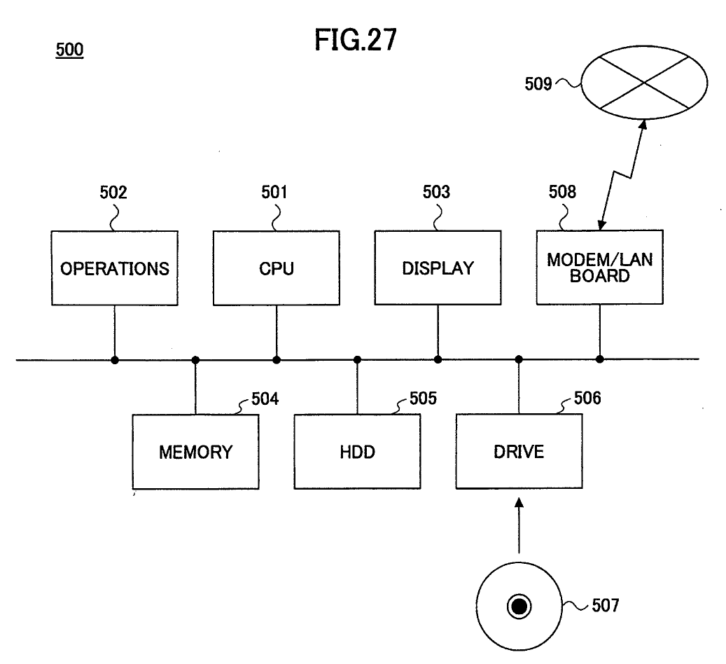

FIG. 27 is a diagram for illustrating a hardware configuration of a computer applicable as the interrogator host 10 in the circular document management system shown in FIGS. 1A and 1B.

Referring to FIG. 27, a computer 500 includes a CPU 501 for executing various operations by executing instructions forming a given program; an operations part 502 for an operator (such as a system administrator) entering operational instructions or data, the operations part 502 including a keyboard and a mouse; a display part 503 that displays the progress and results of processing by the CPU 501 to the operator, the display part 503 including a CRT or liquid crystal display; a storage medium such as a memory 504 that stores programs executed by the CPU 501 and data and is used as a work area, the memory 504 including a ROM and a RAM; a storage medium such as a hard disk unit 505 (corresponding to the hard disk unit 50 of FIG. 1B) that contains programs and data; a CD-ROM drive 506 for loading external programs and data through a storage medium such as a CD-ROM 507; and a modem for downloading programs from a predetermined external server through a communications network 509 (corresponding to the network NW in FIG. 1B) such as the Internet or a LAN or a LAN board for communications with a client through the communications network 509. The modem and LAN board are collectively referred to by the same reference numeral 508 in FIG. 27. Here, examples of storage media are not limited to those described above, and may include those accessible through a computer connected via communications devices such as the modem/LAN board 508.

The computer 500 loads or downloads programs formed of instructions for causing the CPU 501 to execute operations executed by the interrogator host 10, such as the operations described above with reference to FIG. 4 through FIG. 26B, that is, the computer 500 loads or downloads programs such as the above-described user service control program and circulation status monitoring operation program, through the CD-ROM 507 or the communications network 509. Then, the programs are installed into the hard disk unit 505, and are suitably loaded into the memory 504 to be executed by the CPU 501. As a result, the interrogator host 10 forming part of the circular document management system according to the embodiment of the present invention is implemented by the computer 500.

According to the above-described circular document management system of the embodiment of the present invention, there is no particular need to create a circulation list, so that there is no concern about the loss of the circulation list. Nor is it necessary for each individual of circulation destination to write down a date of circulation or the like with respect to each circular. Further, it is possible to immediately locate a document in circulation. Accordingly, it is possible to provide a system capable of managing the circulation status of a circular document with efficiency and effectiveness.

According to one aspect of the present invention, by determining by which one of interrogator antennas provided for corresponding individual persons an object identification tag attached to a circular object is detected, it is determined that the object belongs to one of the individual persons for which the one of the interrogator antennas is provided. A table in which the correspondence between the object identification tag and the object to be circulated is recorded is provided. As a result, the object, whose circulation status is managed with the object identification tag, is easily identifiable by referring to the table.

Consequently, when the circular object is delivered to each of the individual persons of circulation destination, the object identification tag attached to the circular object is detected by the interrogator antenna provided for the individual person, so that it is determined that the circular object has been delivered (circulated) to the individual person. Accordingly, it is not necessary for each individual person of circulation destination to sign a document to indicate that the circular object has been circulated to the individual person. Further, it is possible for a host managing circulation to easily determine the current position of the circular object by identifying one of the interrogator antennas that has detected the object identification tag.

Further, in this case, since the table for recording the correspondence between the object identification tag and the object to be circulated is provided, and the object, whose circulation status is managed with the object identification tag, is identified by referring to the table, it is possible to repeatedly use the object identification tag by removing the object identification tag from the object after its circulation is finished and attaching or sticking the object identification tag onto another circular object. Even in this case, it is sufficient to update the record (field) of the circular document in the table to the new object. Accordingly, it is possible to make effective use of the object identification tag.

Further, in the case of determining that the object having the object identification tag attached thereto belongs to the one of the individual persons for which the one of the interrogator antennas is provided by determining by which one of the interrogator antennas the object identification tag attached to the circular object is detected, it may be determined that the object. belongs to the one of the individual persons in response to further detecting an individual identification tag for identifying the one of the individual persons through the one of the interrogator antennas provided for the one of the individual persons.

According to this configuration, it is not determined that the object belongs to the one of the individual persons before not only the object identification tag is detected through the one of the interrogator antennas but also the individual identification tag for identifying the one of the individual persons for whom the one of the interrogator antennas is provided is also detected through the one of the interrogator antennas, that is, personal authentication is established. Therefore, in the case where a circular object is delivered to an individual person and the object identification tag is detected by a corresponding interrogator antenna, but a third party other than the individual person takes out the circular object, the individual identification tag of the individual person is not detected, so that personal authentication is not established. Accordingly, in such a case, it is correctly determined that the circular object has not belonged to the individual person.

Thus, according to one aspect of the present invention, it is possible to provide a circulation management system capable of managing a circular object with efficiency and effectiveness, making effective use of an object identification tag, and effectively preventing omission of a circulation destination by performing personal authentication as well.

Further, according to one embodiment of the present invention, there is also provided a circulation management method using an object identification tag attached to an object for identifying the object and a plurality of interrogator antennas for detecting the object identification tag, the interrogator antennas being provided for corresponding destinations to which the object is circulated, the circulation management method including the steps of determining by which one of the interrogator antennas the object identification tag is detected, thereby determining that the object having the object identification tag attached thereto belongs to one of the destinations for which the one of the interrogator antennas is provided; and providing a table in which a correspondence between the object identification tag and the object is recorded, storing the table in a storage unit, and identifying the object, whose circulation status is managed by attaching the object identification tag thereto, by reading the table from the storage unit and referring to the table (Configuration 1).

Additionally, the circulation management method as set forth above in Configuration 1 may include the steps of attaching a plurality of destination identification tags to the corresponding destinations for identifying the destinations, the destinations being individual persons; and determining that the object belongs to the one of the destinations in response to detecting the object identification tag and one of the destination identification tags for identifying the one of the destinations through the one of the interrogator antennas provided for the one of the destinations.

Additionally, the circulation management method as set forth above in Configuration 1 may include the step of determining by which one of the interrogator antennas the object identification tag is detected by switching in order between the interrogator antennas in a predetermined manner, thereby determining that the object having the object identification tag attached thereto belongs to the one of the destinations for which the one of the interrogator antennas is provided.

Further, according to one embodiment of the present invention, there is also provided a circulation management method using an object identification tag attached to an object for identifying the object; a plurality of interrogator antennas for detecting the object identification tag, the interrogator antennas being provided for corresponding individual persons to whom the object is circulated; and a plurality of individual identification tags attached to the corresponding individual persons for identifying the individual persons, the circulation management method including the steps of determining that the object belongs to one of the individual persons in response to detecting the object identification tag and one of the individual identification tags for identifying the one of the individual persons through one of the interrogator antennas provided for the one of the individual persons; and updating data of a table contained in a storage unit in accordance with a result of the determination, the table having a circulation status recorded therein (Configuration 2).

Additionally, the circulation management method as set forth above in Configuration 2 may include the steps of determining through which one of the interrogator antennas the object identification tag is detected by switching in order between the interrogator antennas in a predetermined manner; and determining that the object having the object identification tag attached thereto belongs to the one of the individual persons for whom the one of the interrogator antennas is provided in response to further detecting the one of the individual identification tags for identifying the one of the individual persons through the one of the interrogator antennas provided for the one of the individual persons.

Further, according to one embodiment of the present invention, there is also provided a computer-readable storage medium which stores a computer-readable program for causing a computer to execute a circulation management method using an object identification tag attached to an object for identifying the object and a plurality of interrogator antennas for detecting the object identification tag, the interrogator antennas being provided for corresponding destinations to which the object is circulated, the circulation management method including the steps of determining by which one of the interrogator antennas the object identification tag is detected, thereby determining that the object having the object identification tag attached thereto belongs to one of the destinations for which the one of the interrogator antennas is provided; and providing a table in which a correspondence between the object identification tag and the object is recorded, and identifying the object, whose circulation status is managed by attaching the object identification tag thereto, by referring to the table (Configuration 3).

Additionally, in the computer-readable storage medium as set forth above in Configuration 3, a plurality of destination identification tags may be attached to the corresponding destinations for identifying the destinations, the destinations being individual persons; and the circulation management method may include the step of determining that the object belongs to the one of the destinations in response to detecting the object identification tag and one of the destination identification tags for identifying the one of the destinations through the one of the interrogator antennas provided for the one of the destinations.

Additionally, in the computer-readable storage medium as set forth above in Configuration 3, the circulation management method may include the step of determining by which one of the interrogator antennas the object identification tag is detected by switching in order between the interrogator antennas in a predetermined manner, thereby determining that the object having the object identification tag attached thereto belongs to the one of the destinations for which the one of the interrogator antennas is provided.

Further, according to one embodiment of the present invention, there is also provided a computer-readable storage medium which stores a computer-readable program for causing a computer to execute a circulation management method using an object identification tag attached to an object for identifying the object; a plurality of interrogator antennas for detecting the object identification tag, the interrogator antennas being provided for corresponding individual persons to whom the object is circulated; and a plurality of individual identification tags attached to the corresponding individual persons for identifying the individual persons, the circulation management method including the step of determining that the object belongs to one of the individual persons in response to detecting the object identification tag and one of the individual identification tags for identifying the one of the individual persons through one of the interrogator antennas provided for the one of the individual persons (Configuration 4).

Additionally, in the computer-readable storage medium as set forth above in Configuration 4, the circulation management method may include the steps of determining through which one of the interrogator antennas the object identification tag is detected by switching in order between the interrogator antennas in a predetermined manner; and determining that the object having the object identification tag attached thereto belongs to the one of the individual persons for whom the one of the interrogator antennas is provided in response to further detecting the one of the individual identification tags for identifying the one of the individual persons through the one of the interrogator antennas provided for the one of the individual persons.

The present invention is not limited to the specifically disclosed embodiment, and variations and modifications may be made without departing from the scope of the present invention.

The present application is based on Japanese Priority Patent Application No. 2007-065618, filed on Mar. 14, 2007, the entire contents of which are hereby incorporated by reference.

What is claimed is:

1. A circulation management system, comprising:
an object identification tag attached to an object for identifying the object;
a plurality of interrogator antennas for detecting the object identification tag, the interrogator antennas being provided for corresponding destinations to which the object is circulated; and
a management apparatus to which the interrogator antennas are connected,
wherein the management apparatus is configured to determine by which one of the interrogator antennas the object identification tag is detected, thereby determining that the object having the object identification tag attached thereto belongs to one of the destinations for which the one of the interrogator antennas is provided, and
a table is provided in which a correspondence between the object identification tag and the object is recorded, and the object whose circulation status is managed by attaching the object identification tag thereto is identified by referring to the table.

2. The circulation management system as claimed in claim 1, further comprising:
a plurality of destination identification tags attached to the corresponding destinations for identifying the destinations, the destinations being individual persons,
wherein the management apparatus is configured to determine that the object belongs to the one of the destinations in response to detecting the object identification tag and one of the destination identification tags for identifying the one of the destinations through the one of the interrogator antennas provided for the one of the destinations.

3. The circulation management system as claimed in claim 1, wherein the management apparatus is configured to determine by which one of the interrogator antennas the object identification tag is detected by switching in order between the interrogator antennas in a predetermined manner, thereby determining that the object having the object identification tag attached thereto belongs to the one of the destinations for which the one of the interrogator antennas is provided.

4. A circulation management system, comprising:
an object identification tag attached to an object for identifying the object;
a plurality of interrogator antennas for detecting the object identification tag, the interrogator antennas being provided for corresponding individual persons to which the object is circulated;
a plurality of individual identification tags attached to the corresponding individual persons for identifying the individual persons; and
a management apparatus to which the interrogator antennas are connected,
wherein the management apparatus is configured to determine that the object belongs to one of the individual persons in response to detecting the object identification tag and one of the individual identification tags for identifying the one of the individual persons through one of the interrogator antennas provided for the one of the individual persons.

5. The circulation management system as claimed in claim 4, wherein the management apparatus is configured to determine through which one of the interrogator antennas the object identification tag is detected by switching in order between the interrogator antennas in a predetermined manner, and to determine that the object having the object identification tag attached thereto belongs to the one of the individual persons for whom the one of the interrogator antennas is provided in response to further detecting the one of the individual identification tags for identifying the one of the individual persons through the one of the interrogator antennas provided for the one of the individual persons.

6. A circulation management apparatus using an object identification tag attached to an object for identifying the object and a plurality of interrogator antennas for detecting the object identification tag, the interrogator antennas being provided for corresponding destinations to which the object is circulated, the circulation management apparatus comprising:
a determination part configured to determine by which one of the interrogator antennas the object identification tag is detected, thereby determining that the object having the object identification tag attached thereto belongs to one of the destinations for which the one of the interrogator antennas is provided;
a table provision part configured to provide a table in which a correspondence between the object identification tag and the object is recorded; and
an identification part configured to identify the object, whose circulation status is managed by attaching the object identification tag thereto, by referring to the table.

7. The circulation management apparatus as claimed in claim 6, wherein the determination part is configured to determine that the object belongs to the one of the destinations in response to detecting the object identification tag and one of destination identification tags attached to the corresponding destinations for identifying the destinations through the one of the interrogator antennas provided for the one of the destinations, the destinations being individual persons.

8. The circulation management apparatus as claimed in claim 6, wherein the determination part is configured to determine by which one of the interrogator antennas the object identification tag is detected by switching in order between the interrogator antennas in a predetermined manner, thereby determining that the object having the object identification tag attached thereto belongs to the one of the destinations for which the one of the interrogator antennas is provided.

9. A circulation management apparatus using an object identification tag attached to an object for identifying the object; a plurality of interrogator antennas for detecting the object identification tag, the interrogator antennas being provided for corresponding individual persons to which the object is circulated; and a plurality of individual identification tags attached to the corresponding individual persons for identifying the individual persons, the circulation management apparatus comprising:
a determination part configured to determine that the object belongs to one of the individual persons in response to detecting the object identification tag and one of the individual identification tags for identifying the one of the individual persons through one of the interrogator antennas provided for the one of the individual persons.

10. The circulation management apparatus as claimed in claim 9, wherein the determination part is configured to determine through which one of the interrogator antennas the object identification tag is detected by switching in order between the interrogator antennas in a predetermined manner, and to determine that the object having the object identification tag attached thereto belongs to the one of the individual persons for whom the one of the interrogator antennas is provided in response to further detecting the one of the individual identification tags for identifying the one of the individual persons through the one of the interrogator antennas provided for the one of the individual persons.
